(19) United States
(12) Patent Application Publication
(10) Pub. No.: US 2013/0291901 A1
(43) Pub. Date: Nov. 7, 2013

(54) Hyperbaric Methods and Systems for Surface Treatment, Cleaning, and Drying

(71) Applicant: ADVANCED WET TECHNOLOGIES GMBH, Huefingen (DE)

(72) Inventor: Richard W. Plavidal, Milpitas, CA (US)

(73) Assignee: Advanced Wet Technologies GmbH, Huefingen (DE)

(21) Appl. No.: 13/888,338

(22) Filed: May 6, 2013

Related U.S. Application Data
(60) Provisional application No. 61/643,328, filed on May 6, 2012.
(60) Provisional application No. 61/643,329, filed on May 6, 2012.
(60) Provisional application No. 61/643,330, filed on May 6, 2012.
(60) Provisional application No. 61/643,332, filed on May 6, 2012.

(51) Int. Cl. B08B 3/04; B08B 7/04

(52) U.S. Cl. CPC B08B 3/04; B08B 7/04
USPC 134/30

(57) ABSTRACT

Objects with complex surface profiles can be cleaned effectively using hyperbaric pressure. After partially submerging an object in a superheated liquid, the pressure of the vapor portion of the superheated liquid can be cycled. For example, a valve connected to the vapor portion of the superheated liquid can be opened to an ambient, such as atmospheric ambient to release the chamber pressure. The chamber pressure then can increased, for example, by re-equilibrium or by introducing superheated vapor or heated vapor or gas. During the release of pressure, bubbles can formed on the surface of the object. During the increase of the pressure, the bubbles can be collapsed. The cycling of the bubbles can clean the object surface.

This application claims priority from U.S. provisional patent application Ser. No. 61/643,328, filed on May 6, 2012, entitled “Hyperbaric Methods and Systems for Surface Treatment, Cleaning, and Drying”, from U.S. provisional patent application Ser. No. 61/643,329, filed on May 6, 2012, entitled “Hyperbaric Methods and Systems for Surface Treatment, Cleaning, and Drying”, from U.S. provisional patent application Ser. No. 61/643,330, filed on May 6, 2012, entitled “Hyperbaric Methods and Systems for Surface Treatment, Cleaning, and Drying”, from U.S. provisional patent application Ser. No. 61/643,332, filed on May 6, 2012, entitled “Hyperbaric Methods and Systems for Surface Treatment, Cleaning, and Drying”, which are incorporated herein by reference.

This application is related to co-pending U.S. application Ser. No. 13/865,208, filed on Apr. 18, 2013, entitled “Hyperbaric methods and systems for rinsing and drying granular materials”, which is incorporated herein by reference.

This application is related to co-pending U.S. application Ser. No. 13/869,036, filed on Apr. 24, 2013, entitled “Hyperbaric CNX for Post-Wafer-Saw Integrated Clean, De-Glue, and Dry Apparatus & Process”, which is incorporated herein by reference.

This application is related to co-pending U.S. application Ser. No. 13/733,119, filed on Jan. 2, 2013, entitled “Methods and systems for cleaning for cyclic nucleation transport (CNX)”, which is incorporated herein by reference.

### BACKGROUND

Parts or devices with complex shapes pose a special challenge for surface treatment and cleaning due to small openings, internal dead spaces, blind holes and other hard to access places within the part. Traditional sprays and sonic agitation cannot access these areas effectively and even if they could it would be difficult or impossible to remove chemical byproducts, loosened debris and contaminated cleaning solutions from these parts. Even complex manifold flow connections cannot effectively flush contamination from trapped areas and dead spaces within some parts.

### SUMMARY

In some embodiments, cleaning methods using hyperbaric pressure are provided. After partially submerging an object in a superheated liquid, the vapor portion of the superheated liquid can be periodically released. For example, a valve connected to the vapor portion of the superheated liquid can be opened to an ambient, such as atmospheric ambient to release the chamber pressure. The valve then can be close, and the chamber pressure can be increased, due to the re-equilibrium of the superheated liquid. During the release of pressure, bubbles can formed on the surface of the object. During the re-equilibrium of the superheated liquid, the bubbles can be collapsed. The cycling of the bubbles can clean the object surface.

In some embodiments, the vapor portion of the superheated liquid can be periodically oscillated. For example, a valve connected to the vapor portion of the superheated liquid can be opened to an ambient, such as atmospheric ambient to release the chamber pressure. The valve then can be close. Another valve can be opened to introduce a superheated vapor or a saturated vapor to the chamber to increase the chamber pressure. During the release of pressure, bubbles can formed on the surface of the object. During the increase of the pressure, the bubbles can be collapsed. The cycling of the bubbles can clean the object surface.

In some embodiments, a heated vapor or a heated gas can be introduced to the chamber to increase the chamber pressure.

In some embodiments, drying methods using hyperbaric pressure are provided. After providing a superheated vapor to a chamber, the superheated vapor can be quickly released. During the release of pressure, liquid droplets can be evaporated, drying the object. In some embodiments, integrated systems using hyperbaric pressure for cleaning and drying are provided. After cleaning with a superheated liquid, using cyclic pressure, an object can be cleaned with a superheated vapor.

### BRIEF DESCRIPTION OF THE DRAWINGS

FIGS. 1A-1B illustrate exemplary regimes of operation according to some embodiments.

FIGS. 2A-2C illustrate an exemplary cyclic nucleation process at a hyperbaric pressure according to some embodiments.

FIGS. 3A-3B illustrates exemplary pressure flows for a hyperbaric process according to some embodiments.

FIGS. 4A-4B illustrates exemplary energy flows for a hyperbaric process according to some embodiments.

FIGS. 5A-5B illustrate exemplary system configurations for a hyperbaric process according to some embodiments.

FIGS. 6A-6B illustrate exemplary flow charts for a hyperbaric cyclic nucleation process according to some embodiments.

FIG. 7 illustrates another exemplary flow chart for a hyperbaric cyclic nucleation process according to some embodiments.

FIG. 8 illustrates another exemplary flow chart for a hyperbaric cyclic nucleation process according to some embodiments.

FIG. 9 illustrates another exemplary flow chart for a hyperbaric cyclic nucleation process according to some embodiments.

FIGS. 10A-10B illustrate exemplary system configurations for a hyperbaric process according to some embodiments.

FIGS. 11A-11C illustrate an exemplary cyclic nucleation process at a hyperbaric pressure according to some embodiments.

FIGS. 12A-12C illustrate another exemplary cyclic nucleation process at a hyperbaric pressure according to some embodiments.

FIGS. 13A-13B illustrates exemplary pressure flows for a hyperbaric process according to some embodiments.

FIGS. 14A-14B illustrates exemplary energy flows for a hyperbaric process according to some embodiments.

FIG. 15 illustrates an exemplary flow chart for a hyperbaric cyclic nucleation process according to some embodiments.

FIG. 16 illustrates another exemplary flow chart for a hyperbaric cyclic nucleation process according to some embodiments.

FIG. 17 illustrates another exemplary flow chart for a hyperbaric cyclic nucleation process according to some embodiments.

FIG. 18 illustrates another exemplary flow chart for a hyperbaric cyclic nucleation process according to some embodiments.

FIG. 19 illustrates another exemplary flow chart for a hyperbaric cyclic nucleation process according to some embodiments.

FIG. 20 illustrates another exemplary flow chart for a hyperbaric cyclic nucleation process according to some embodiments.

FIGS. 21A-21B illustrate exemplary system configurations for a hyperbaric process according to some embodiments.

FIGS. 22A-22C illustrate an exemplary cyclic nucleation process at a hyperbaric pressure according to some embodiments.

FIGS. 23A-23C illustrate another exemplary cyclic nucleation process at a hyperbaric pressure according to some embodiments.

FIGS. 24A-24B illustrates exemplary pressure flows for a hyperbaric process according to some embodiments.

FIG. 25 illustrates an exemplary flow chart for a hyperbaric cyclic nucleation process according to some embodiments.

FIG. 26 illustrates another exemplary flow chart for a hyperbaric cyclic nucleation process according to some embodiments.

FIG. 27 illustrates another exemplary flow chart for a hyperbaric cyclic nucleation process according to some embodiments.

FIG. 28 illustrates another exemplary flow chart for a hyperbaric cyclic nucleation process according to some embodiments.

FIG. 29 illustrates another exemplary flow chart for a hyperbaric cyclic nucleation process according to some embodiments.

FIGS. 30A-30B illustrate an exemplary cleaning and drying process utilizing hyperbaric vapor pressure according to some embodiments.

FIG. 31 illustrates an exemplary system configuration for cleaning and/or drying an object according to some embodiments.

FIGS. 32A-32B illustrate another exemplary cleaning and drying process utilizing hyperbaric vapor pressure according to some embodiments.

FIG. 33 illustrates another exemplary system configuration for cleaning and/or drying an object according to some embodiments.

FIGS. 34A-34B illustrate exemplary flow charts for a hyperbaric drying process according to some embodiments.

FIGS. 35A-35C illustrate an exemplary cleaning and drying process utilizing hyperbaric vapor pressure according to some embodiments.

FIG. 36 illustrates another exemplary flow chart for a hyperbaric drying process according to some embodiments.

FIG. 37 illustrates an exemplary system configuration for cyclic cleaning and drying an object according to some embodiments.

FIG. 38 illustrates an exemplary system configuration for cyclic processing and/or cleaning and drying an object according to some embodiments.

FIG. 39 illustrates an exemplary flow chart for a hyperbaric cyclic cleaning (or other processing) and drying process according to some embodiments.

FIG. 40 illustrates an exemplary flow chart for a hyperbaric cyclic cleaning/processing and drying process according to some embodiments.

FIGS. 41A-41B illustrate a schematic of a VCPRC and a process to prepare the VCPRC to be used with a hyperbaric chamber according to some embodiments.

FIGS. 42A-42B illustrate an operation of a hyperbaric process using a VCPRC according to some embodiments.

FIG. 43 illustrates a draining operation for a VCPRC according to some embodiments.

FIGS. 44A-44B illustrate pressure-temperature diagrams according to some embodiments.

FIG. 45 illustrates a flow chart for initializing a VCPRC according to some embodiments.

FIG. 46 illustrates a flow chart for running a VCPRC according to some embodiments.

### DETAILED DESCRIPTION OF THE EMBODIMENTS

The development of CNX (Cyclic Nucleation Transport) Technology represented a breakthrough in addressing the aforementioned problem. With CNX it was possible to grow and collapse vapor bubbles which would displace fluids and dislodge contamination from hidden surfaces. Furthermore the nucleation process is independent of boundary layers and geometries which would otherwise block any cleaning agitation or displacement. A key attribute of CNX is that all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the surface.

In some embodiments, the present invention discloses methods and apparatuses for surface processing, cleaning and drying an object using cyclic nucleation technology with hyperbaric pressure. Hyperbaric pressure process can significantly simplify the cleaning and drying equipment, for example, by eliminating vacuum pumps or power during the cyclic process. In addition, hyperbaric pressure process can extend the temperature ranges, which can lead to faster reaction rates, increasing processing speed and cleaning effectiveness. Further, the consumables can be less expensive and more environment friendly, for example, water and steam at elevated temperatures can be used instead of highly reactive chemicals.

In some embodiments, the present invention discloses a hyperbaric cyclic cleaning process, comprising pressure cycling liquid and/or vapor from pressure higher than atmospheric pressure. In some embodiments, higher pressure is accompanied by higher temperature, which provides additional benefits of more efficient cleaning and cheaper liquid medium. In addition, greater pressure cycles can be achieved when cycling from high pressure.

In some embodiments, the present invention discloses a hyperbaric cyclic cleaning process, comprising cycling liquid and/or vapor across the boiling point of the liquid. The cycling can be performed by varying pressure, for example, from a pressure equal to or higher than the boiling pressure of the liquid (and higher than atmospheric pressure in some embodiments) to a pressure lower than or equal to the boiling pressure of the liquid (which can be higher or lower than atmospheric pressure). At the pressure lower than the boiling point, the liquid starts to boil, generating bubbles. The process conditions are preferably controlled so that the bubbles are generated at the surface of an object that is at least partially submerged in or wetted with the liquid. For example, at onset of boiling, bubbles are mostly generated at the surfaces of the object, thus in some embodiments, the pressure reduction is controlled to maintain the onset of boiling condition, avoiding the rigorous boiling regime in which the bubbles are generated within the liquid.

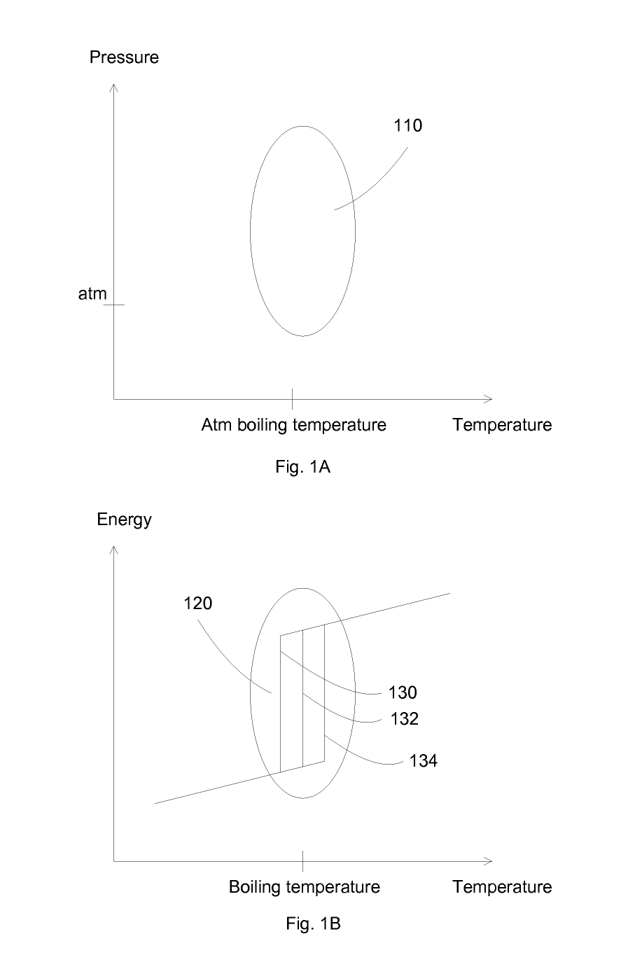

FIGS. 1A-1B illustrate exemplary regimes of operation according to some embodiments. In FIG. 1A, a temperature-pressure curve is showed, illustrating the exemplary operation regime 110 of the present invention, which is preferably above the atmospheric pressure, and the corresponding boiling temperature, i.e., boiling temperature at atmospheric pressure. The process regime preferably comprises regions with higher pressure than the atmospheric pressure, and at temperatures higher than the boiling temperature at atmospheric pressure. In FIG. 1B, temperature-energy curves are showed, illustrating the exemplary operation regime 120 of the present invention, which is preferably surrounding the transition temperatures 130-134, corresponded to different pressures. The transition temperature is generally the boiling temperature, for example, 100° C. at atmospheric pressure for water, and higher or lower temperatures at higher or lower pressures, respectively. In some embodiments, the present invention discloses cyclic hyperbaric process, with the operating regime surrounding the transition temperature at pressure higher than the atmospheric pressure.

In some embodiments, the present invention discloses a hyperbaric CNX (H-CNX) process, which can provide significant benefits, including expanded temperature ranges, e.g., higher temperatures are associated with faster reaction rates which increases part processing speed and cleaning effectiveness; greater use of pure water and steam at elevated temperatures to clean without the use of dangerous, expensive, or environmentally unfriendly chemicals; more efficient drying, which can be aided by the elevated temperatures as well as the ability for expanding vapor bubbles to rapidly displace trapped liquid on the surfaces of a part; elimination of vacuum pumps since pressure can be released to atmospheric pressure; sterilization which may be accomplished in-situ with the cleaning process since autoclave conditions can be achieved as a natural consequence of H-CNX processing; usage of DI water, which at high temperature and pressure can offer superior cleaning and degreasing without solvents; simple design; and in-situ drying using saturated or superheated steam.

In some embodiments, at the transition regime, the object is submerged in the liquid portion for cyclic nucleation cleaning The term “submerged” is used in the present invention to mean “at least partially submerged”, including “totally submerged” (where the object is completed enclosed by the liquid) and “partially submerged” (where the object is partially within the liquid portion and partially in the vapor portion).

In some embodiments, the present invention discloses a hyperbaric cyclic nucleation process, comprising cycling pressure from above atmospheric to above, about or below atmospheric pressure. The pressure can be the vapor phase pressure of the liquid medium or the pressure of the headspace above the liquid medium. For example, a liquid medium can partially fill a container, leaving a head space portion of the container for the vapor. At equilibrium, the head space contains the vapor phase of the liquid medium. Alternatively, the head space can be pressurized, causing the vapor above the liquid surface to have a pressure higher than the equilibrium vapor pressure of the liquid. The liquid medium can also totally fill the container.

In some embodiments, the present invention relates to cyclic nucleation processes and systems, which comprises generating and terminating bubbles. The bubbles act to displace and transport chemicals, contamination, particles and debris to and from surfaces. In some embodiments, the present invention discloses a cyclic nucleation process in which energy is gradually released from the liquid medium to generate and terminate bubbles for cleaning For example, a liquid medium can be brought to a state having high internal energy, such as providing thermal energy to a pressure above the atmospheric pressure and a temperature above the boiling temperature at atmospheric pressure (but below the boiling temperature of the pressure of the liquid). The energy can be released in such a way to cyclically generate and terminate bubbles at the object surface, processing and cleaning the object surface with the bubble energy. For example, by temporarily releasing the pressure of the liquid to below the boiling point, e.g., atmospheric pressure by opening a relief valve, the bubbles are generated. The pressure release process can be performed without actively acting on the temperature of the liquid, thus the liquid temperature can be unchanged or slightly changed, depending on the equipment and process. Then the pressure release is terminated, and equilibrium can be re-established. For example, the relief valve is closed, and vapor pressure is built up to equilibrium. The equilibrium point is preferably above the boiling point, e.g., the liquid pressure is higher than the boiling pressure of the liquid temperature, and thus the bubbles are terminated, acting to bring fresh fluid and energy to clean the object surface, for example, by releasing the energy to the particulates adhering to the object surface. The process can be repeated until the object is cleaned, or until the internal energy is no longer adequate to perform the pressure cycling. In some embodiments, additional energy can be provided.

In some embodiments, the present invention can simplify the equipment and process, for example, with energy applied only at the beginning to provide high internal energy to the liquid medium. The subsequent cyclic nucleation transport action can be performed by simply toggling the relief valve at a frequency optimal for the cleaning process.

For example, an object can be disposed in a liquid medium having high internal energy, and then the internal energy is reduced to form bubbles in the liquid medium. At the beginning, the bubbles tend to nucleate at the object surface. With more energy released, the bubbles can form in the liquid medium. The bubbles are then terminated when at the surface, and during the collapse of the bubbles, energy can be provided to the object surface, removing any adhering contamination or residue. The cycling of bubbles, generation and termination, can act to clean the object surface, even at hard to reach places. The high internal energy can be in the form of high temperature, high pressure liquid, and the energy released can be in the form of pressure released, reducing the internal energy of the liquid.

In some embodiments, an object is partially or totally submerged in a liquid medium in a sealed container. The liquid can partially or totally fill the container. The liquid medium has a vapor phase pressure above the atmospheric pressure. The liquid medium is not boiling or not at an onset of boiling, meaning there is no bubble formation within the liquid, either at the object surface or at the liquid medium. The pressure within the sealed container is decreased, for example, by opening a relief valve to the atmosphere. Since the liquid medium is at higher vapor pressure, reducing the pressure can lead to bubble formation, e.g., onset of boiling with bubbles nucleated at the object surface. The pressure within the sealed container is then increased, for example, preferably by closing the relief valve. The bubbles are then terminated as the pressure stabilizes at the vapor pressure. The pressure cycling is repeated, with the pressure cycles at above atmospheric pressure. The cycling of bubbles, e.g., repeated sequence of bubble formation and termination, can lead to a chemical processing or cleaning of the object surface.

In some embodiments, the head space can be coupled to a pressurized container, which can re-pressurize the head space (e.g., the vapor at area above the liquid surface). Thus the vapor pressure can be increased through the pressurizing action.

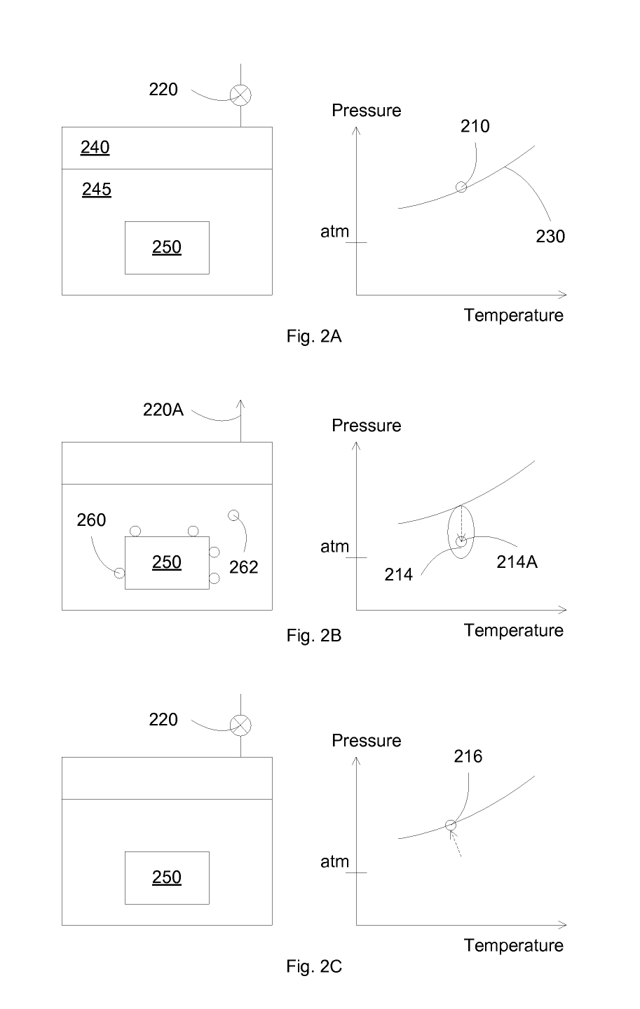

FIGS. 2A-2C illustrate an exemplary cyclic nucleation process at a hyperbaric pressure according to some embodiments. In FIG. 2A, an object 250 is submerged in a liquid 245 in a sealed container. The container is preferably partially filled with the liquid 245, leaving a head space 240 to accommodate the liquid vapor. A relief valve 220 is connected to the vapor portion 240 of the container, which can regulate the pressure in the container. The liquid can have high internal energy, for example, at a temperature and pressure point 210 in an operating region at the boiling curve 230. The operating region 210 is also preferably above the boiling temperature at atmospheric pressure. The liquid pressure therefore is also preferably higher than the atmospheric pressure.

In some embodiments, the liquid comprises water, for example, water or water solutions with dissolved chemicals such as cleaning chemical. In some embodiments, the temperature of the water solutions can be above 100° C., such as between 100 and 200° C. In some embodiments, the pressure of the water solutions can be above atmospheric pressure, such as between 1 and 20 bars.

In some embodiments, the liquid is at the boiling curve, meaning the pressure 240 at the head space above the liquid surface is the vapor pressure of the liquid 245 at the liquid temperature. This condition can be achieved by heating the liquid. As the temperature of the liquid increases, more liquid vapor is generated to move the pressure along the boiling curve.

In FIG. 2B, the relief valve 220 is open (shown in open state 220A) to atmosphere. In some embodiments, the vapor pressure is reduced, for example, by releasing the vapor pressure 240. With adequate drop in vapor pressure, the liquid can initiate boiling, e.g., bubbles 260 can start forming at the surface of the object. For example, the pressure of the container can be dropped to a point 214A below the boiling curve 230, thus boiling the liquid. The point 214A can be within the operating region 214, which can be at or below the boiling curve. The drop in pressure is preferably regulated to optimize the cleaning process, for example, to maximize bubble 260 generation at the surface of the object and minimize bubbles 262 formation within the liquid. For example, the relief valve 220 can be a control valve, allowing a specific opening to the exit.

In FIG. 2C, the pressure can start increasing to pressure 216, which can be at about the boiling curve, thus stopping the boiling process, terminating the bubbles 260 to generate a surface cleaning effect. In some embodiments, the relief valve 220 is closed, and the pressure can start increasing to an equilibrium pressure, for example, the liquid can be vaporized to increase the vapor pressure to reach equilibrium. The pressure 216 is generally at about the boiling pressure, since it is the equilibrium pressure due to the vaporization of the liquid. The temperature can be lower, due to loss of internal energy during the pressure releasing process.

The process can be repeated until the object is cleaned and/or processed, or when an equilibrium is reached, for example, when the internal energy is balanced, or when it is no longer optimized, for example, then the pressure difference is not adequate to cycling bubbles for an effective cleaning process.

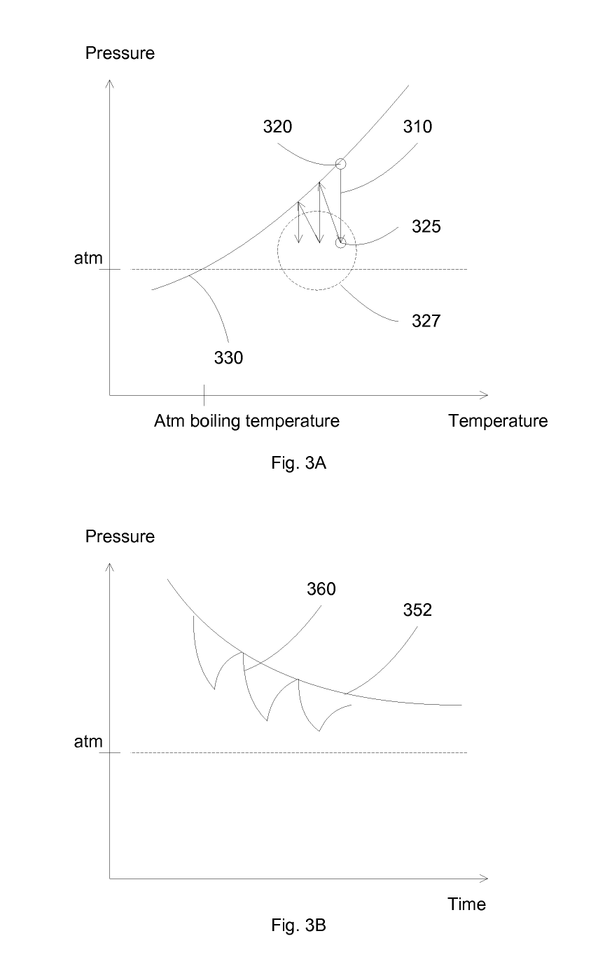

FIGS. 3A-3B illustrates exemplary pressure flows for a hyperbaric process according to some embodiments. In FIG. 3A, the container pressure is cycled 310 across the boiling curve 330, for example, between the high pressure 320 and the low pressure 325 (in operating region 327). The low pressure 325 is preferably also above atmospheric pressure, but in some embodiments, below atmospheric pressure can be used. The cycling pressure can be accompanied by a gradual decrease in temperature, indicating a loss of internal energy. In FIG. 3B, the pressure cycling 360 can be oscillated under the boiling curve 352, which can be reduced with time due to reduced liquid temperature and due to loss of internal energy. For example, the container pressure will be oscillated below the boiling curve. For a well-insulated container, the temperature loss can be reduced, and the boiling curve can exhibit a smaller gradient. The above explanation is oversimplified, and is not meant to limit the scope and validity of the present invention, which is defined by the enclosed claims.

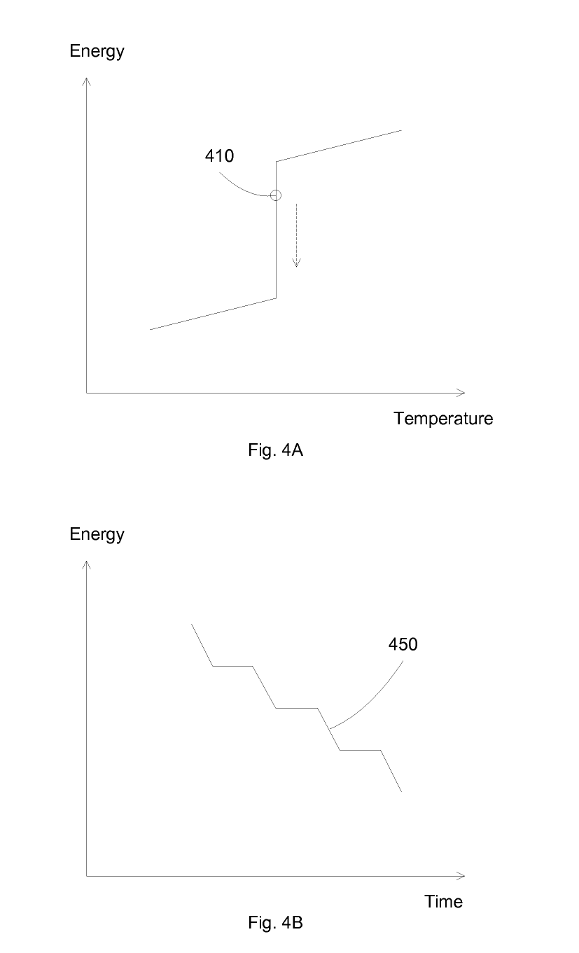

FIGS. 4A-4B illustrates exemplary energy flows for a hyperbaric process according to some embodiments. In FIG. 4A, the internal energy of the liquid is reduced along the vapor-liquid transition section, for example, from a high energy 410 to lower energies. The curve shown is exemplary, and can be drift to lower temperature due to loss of temperature. In FIG. 4B, the energy 450 is shown to be reduced with time, due to the pressure release.

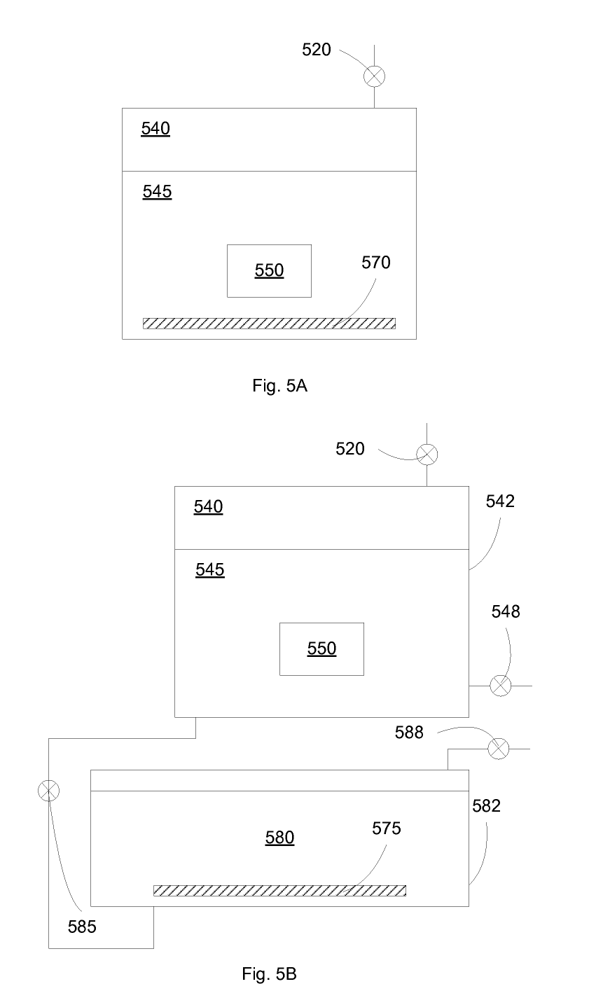

FIGS. 5A-5B illustrate exemplary system configurations for a hyperbaric process according to some embodiments. In FIG. 5A, a chamber containing a liquid 545, which partially filled the chamber with an object 550 submerged in the liquid 545. A heater 570 can be included to heat the liquid to a temperature and pressure above atmospheric pressure. A relief valve 520 is coupled to the chamber to release the chamber pressure. The liquid can be introduced to the chamber, which is then sealed and heated to bring the liquid to a high energy state of high pressure and temperature. Alternatively, a heated liquid can be introduced to the chamber, with the heater maintaining the liquid temperature. Cyclic nucleation process from a hyperbaric pressure can be performed after the heating the liquid, for example, by cycling the relief valve 520 (e.g., repeating opening and closing). The liquid can be constantly or intermittently heated during the cyclic nucleation process.

In some embodiments, the liquid medium can be supplied to the chamber through a reservoir. The reservoir can be heated to maintain a constant supply of liquid at the proper pressure, e.g., hyperbaric pressure, to the chamber. FIG. 5B shows a reservoir 582 to supply liquid to a chamber 542 through a valve 585. Heater 575 can be used to heat the liquid 580 to a pressure above atmospheric pressure. Heater 575 can be constantly heated to maintain the proper temperature and pressure for the liquid 580. Valve 588 can be used to pressurize the reservoir head space. Valve 585 can be open to deliver the heated liquid to the chamber 542, submerging the object 550 within liquid 545, leaving vapor portion 540. A relief valve 520 can be included to open and close, to perform the cyclic nucleation process, cleaning/processing the object 550 by cycling high pressure to lower values, crossing the boiling curve for generating and terminating bubbles. A drain valve 548 can be included for draining the liquid, for example, when the cleaning process is completed.

In some embodiments, by maintaining the liquid at high pressure, the liquid can be brought to a higher temperature without any bubble formation. The present invention thus can enable a cyclic process at high temperature, e.g., higher than the boiling temperature of the liquid medium. The high temperature can allow the use of inexpensive liquid, such as water, for cleaning instead of the more expensive solvent or cleaning chemicals. The high temperature can also allow sterilization, since microscopic organisms cannot survive high temperature exposure, such as 130 or 160 degrees C.

In addition, the present invention can simplify the cleaning equipment, for example, by eliminating the vacuum pump needed to reduce the pressure to below atmospheric pressure. Instead, a relief valve can be used to reduce pressure from a pressure above the atmospheric pressure.

In some embodiments, the present invention discloses systems and processes for hyperbaric cyclic nucleation process. The process chamber pressure release can be used to nucleate and expand vapor and gas bubbles at the surface of a part in order to displace and expel process fluids, reaction byproducts, and/or unwanted debris and contamination from the surface of the part. The process chamber can be re-pressurized immediately after the pressure release and nucleation step to collapse vapor bubbles and flush the part with fresh process fluid as well as introduce energy from the collapse to enhance surface reactions and displace reaction byproducts and/or unwanted debris and contamination from the surface of the part. The re-pressurization can be performed by heating the liquid through a heater, or through adding heated vapor from a reservoir. The process can be repeated.

In some embodiments, the present invention discloses a heated and pressurized process fluid supply reservoir used to deliver hot liquid under controlled pressure to the process chamber. The present invention further discloses a hyperbaric process chamber capable of receiving either liquid or vapor under pressure from the supply reservoir, and capable of releasing vapor under pressure from the process chamber to begin the cyclic nucleation process. The hyperbaric process chamber can be capable of releasing liquid under pressure from the process chamber to drain the chamber and to begin the vapor dry sequence known as “Rapid Displacement Drying”.

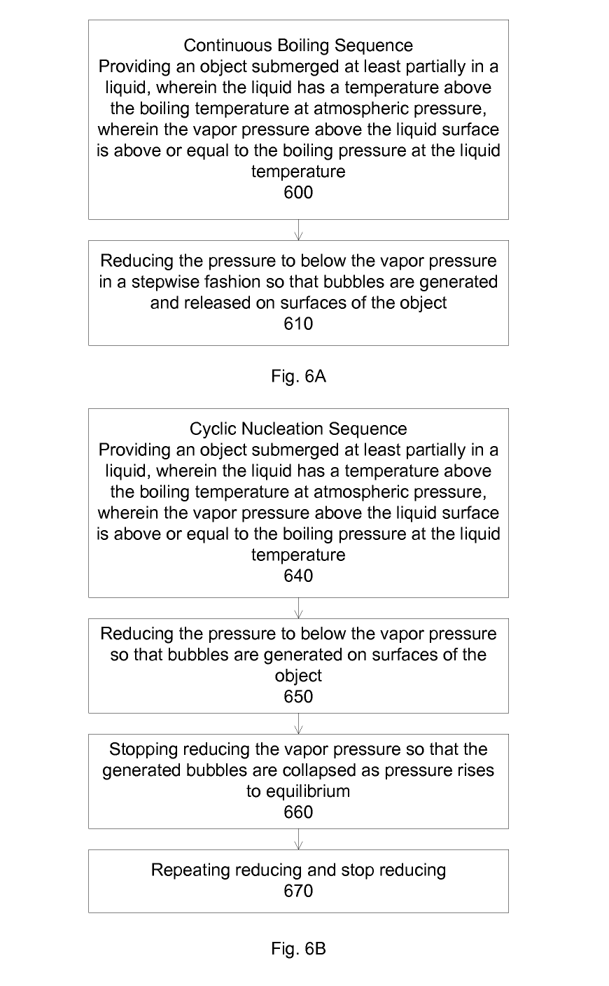

FIGS. 6A-6B illustrate exemplary flow charts for a hyperbaric cyclic nucleation process according to some embodiments. In FIG. 6A, operation 600 provides an object submerged at least partially in a liquid, wherein the liquid has a temperature above the boiling temperature at atmospheric pressure, wherein the vapor pressure above the liquid surface is above or equal to the boiling pressure at the liquid temperature. Operation 610 reduces the pressure to below vapor pressure in a stepwise fashion so that bubbles are generated on surfaces of the object and are released from object surfaces as bubbles grow. This is an example of continuous boiling.

In FIG. 6B, operation 640 provides an object submerged at least partially in a liquid, wherein the liquid has a temperature above the boiling temperature at atmospheric pressure, wherein the vapor pressure above the liquid surface is above or equal to the boiling pressure at the liquid temperature. Operation 650 reduces the vapor pressure so that bubbles are generated on surfaces of the object. Operation 660 stops reducing the pressure so that the generated bubbles are collapsed as pressure rises to equilibrium at the vapor pressure. Operation 670 repeats the steps of reducing and stopping reducing, for example, until the object is processed and/or cleaned.

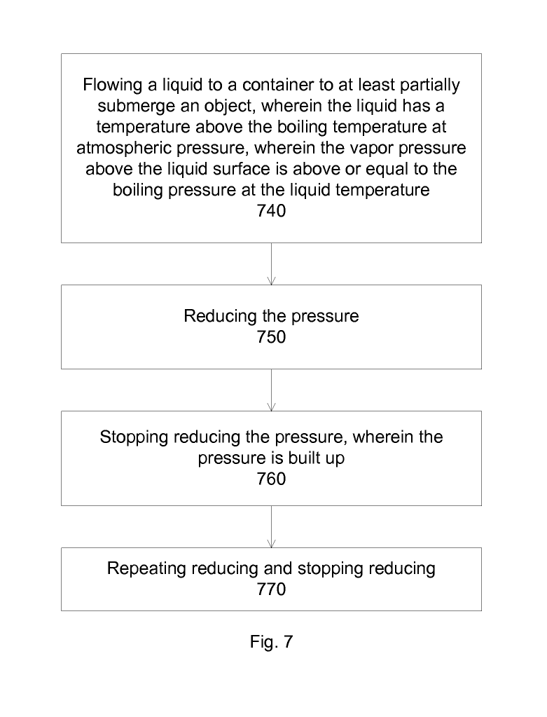

FIG. 7 illustrates another exemplary flow chart for a hyperbaric cyclic nucleation process according to some embodiments. Operation 740 provides a container which is then partially filled with a heated liquid, wherein an object is submerged at least partially in the liquid, wherein the liquid has a temperature above the boiling temperature at atmospheric pressure, wherein the vapor pressure above the liquid surface is above or equal to the boiling pressure at the liquid temperature. Operation 750 reduces the vapor pressure to below the boiling pressure. Operation 760 stops reducing the vapor pressure, wherein the pressure is built up, for example, to the boiling pressure corresponded to the liquid temperature. The liquid temperature can be slowly decreased, thus the pressure can be also gradually decreased. Operation 770 repeats the steps of reducing and stopping reducing.

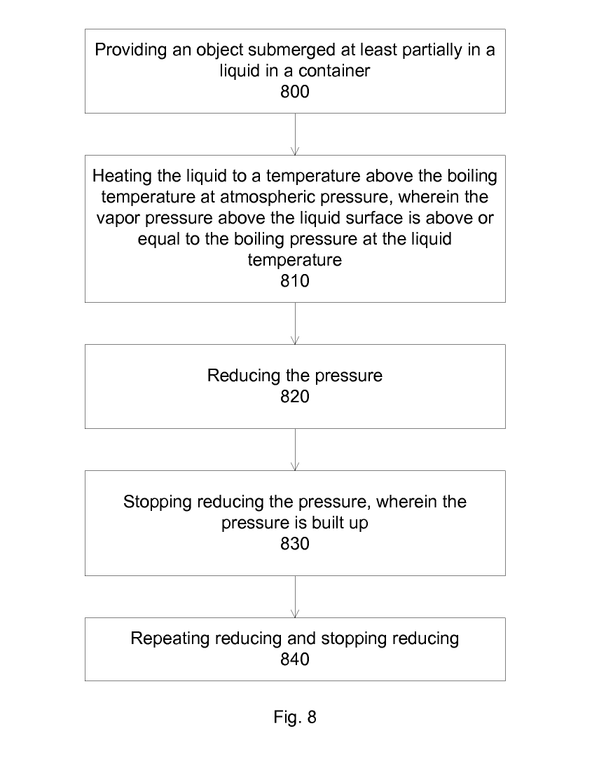

FIG. 8 illustrates another exemplary flow chart for a hyperbaric cyclic nucleation process according to some embodiments. Operation 800 provides an object submerged at least partially in a liquid in a container. Operation 810 heats the liquid to a temperature above the boiling temperature at atmospheric pressure, wherein the vapor pressure above the liquid surface is above or equal to the boiling pressure at the liquid temperature. Operation 820 reduces the pressure, for example, to below the boiling pressure. Operation 830 stops reducing the pressure, wherein the pressure is built up. Operation 840 repeats the steps of reducing and stopping reducing pressure.

In an exemplary process, the process chamber is filled with liquid from the reservoir. Pressure is then cycled, for example, released for the formation of bubbles and increased for the termination of bubbles. The liquid can be drained and replaced with new liquid from the reservoir, and the cleaning cycle is repeated. After complete cleaning and/or surface processing, the liquid can be drained.

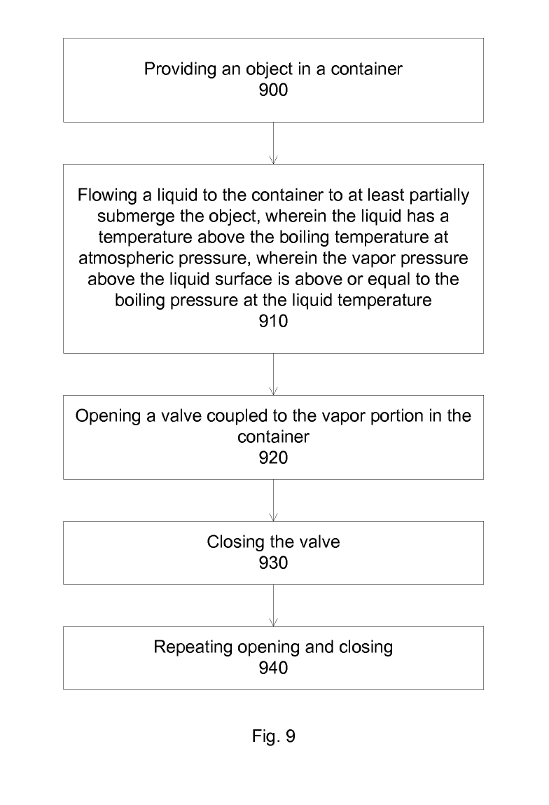

FIG. 9 illustrates another exemplary flow chart for a hyperbaric cyclic nucleation process according to some embodiments. Operation 900 provides an object in a chamber. In some embodiments, the chamber can be sealed and then brought up to a high pressure, e.g., above atmospheric pressure, after the object is loaded into the chamber. The high pressure can be similar to the pressure of a superheated liquid that will be introduced to the chamber for cleaning. The high pressure condition can be established by a gas, such as an inert gas or an inactive gas. Alternatively, a superheated steam can be supplied to the chamber. The superheated steam can be generated together with the superheated liquid, and thus can have the same pressure.

Operation 910 flows a liquid to the chamber to at least partially submerge the object, wherein the liquid has a temperature above the boiling temperature at atmospheric pressure, wherein the vapor pressure above the liquid surface is above or equal to the boiling pressure corresponded to the liquid temperature. A cyclic nucleation process can be performed to clean the object, especially in hard to get areas. Since the chamber pressure is above atmospheric, a chamber valve can be open to release the chamber pressure, thus generating bubbles in the liquid for cleaning The valve can be close, and the pressure can be built up to terminate the bubbles. The valve can be cyclically open and close, which can cyclically releasing and stop releasing pressure in the chamber.

Operation 920 opens a valve coupled to the vapor portion in the container thus causing a reduction in pressure. Operation 930 closes the valve causing pressure to rise. Operation 940 repeats opening and closing, for example, until the object is cleaned or processed.

Other configurations can be used. For example, the pressure can gradually decrease, which can lead to more and more bubbles nucleated at the object surface with minimum bubbles formed within the liquid. The pressure can decrease to a value above atmospheric pressure, above atmospheric pressure, or below atmospheric pressure. Thus the pressure can cycle at two values of pressure wherein both of these values are above atmospheric pressure. Alternatively, the pressure can cycle from an above atmospheric pressure to an about atmospheric pressure. Alternatively, the pressure can cycle from an above atmospheric pressure to a below atmospheric pressure.

In some embodiments, the present invention discloses methods and apparatuses utilizing high energy fluid, such as saturated or superheated steam or water, as the medium for cleaning and drying. Steam can be reduced from a hyperbaric saturated steam (for example, at 5 bar pressure and 160° C.) to atmospheric steam (for example, at 1 bar and 130° C.). High pressure to low pressure can be achieved by adiabatic expansion, for example, through a relief valve. Low pressure to high pressure can be achieved by vaporizing liquid, or by providing a pressurized gas or vapor. The outlet of the relief valve can be released to the atmosphere ambient, a special vacuum condenser pressure relief container, where it can be recycled or properly disposed.

Saturated steam is steam that is in equilibrium with heated water (e.g., saturated water) at the same pressure. For example, at atmospheric pressure, water is boiled at 100C, generating saturated steam and saturated water. If saturated steam is reduced in temperature while keeping the same pressure, it will condense to produce water droplets. For example, saturated water contains as much thermal energy as it can without boiling. Conversely a saturated vapor contains as little thermal energy as it can without condensing.

Superheated steam is steam at a temperature higher than water's boiling point. If saturated steam is heated at constant pressure, its temperature will also remain constant as the steam becomes dry saturated steam. Continued heating will then generate superheated steam.

Superheated water is liquid water under pressure at temperatures between the usual boiling point (100° C.) and the critical temperature (374° C.). It is also known as subcritical water and pressurized hot water. Superheated water can be stable under high pressure, for example, by heating in a sealed vessel with a headspace, where the liquid water is in equilibrium with water vapor at the saturated vapor pressure. This is different with unstable superheating, which refers to water at atmospheric pressure above its normal boiling point and which has not boiled due to a lack of nucleation sites.

In some embodiments, the superheated liquid can be drained to a second chamber, wherein the pressure of the second chamber is similar to that of the first chamber when draining For example, the second chamber can have similar pressure, and thus the connection between the first and second chambers can be performed without significantly changing the pressure in the first chamber. In some embodiments, the process can be repeated, e.g., a superheated liquid can be repeatedly supplied and drained from the chamber, for example, to clean the object to a desired cleanliness.

In some embodiments, the pressure in the first chamber can be reduced to evaporate liquids on the object. After the superheated liquid is drained, the chamber can contain superheated steam. A rapid release of the superheated steam can carry liquid droplets on the object, thus can effectively dry the object. In some embodiments, the process can be repeated, e.g., a new superheated steam can be re-supplied to the chamber, and then re-released for further drying. The new superheated steam can be dry superheated steam.

In some embodiments, a new superheated liquid can be provided to the chamber, after draining the existing superheated liquid. The cyclic nucleation process can be repeated. In some embodiments, a new superheated liquid can be provided to the chamber to bring the chamber to a high pressure before moving to the next step of draining the liquid while keeping the high pressure.

In some embodiments, the superheated liquid can be drained to a second chamber, wherein the pressure of the second chamber is similar to that of the first chamber. After the superheated liquid is drained, the chamber can contain superheated steam. A rapid release of the superheated steam can carry liquid droplets on the object, thus can effectively dry the object. In some embodiments, the process can be repeated, e.g., a new superheated steam can be re-supplied to the chamber, and then re-released for further drying. The new superheated steam can be dry superheated steam.

In some embodiments, cleaning methods using hyperbaric pressure are provided. The methods can include providing an object in a chamber; flowing a superheated liquid to the chamber to at least partially submerge the object, wherein the superheated liquid has a temperature above the boiling temperature at atmospheric pressure, wherein the superheated liquid partially fills the chamber so that the chamber comprises a liquid portion and a vapor portion. The methods can include repeatedly connecting the vapor portion of the chamber to an ambient, wherein the ambient has lower vapor pressure than the chamber; and then disconnecting the connection.

In some embodiments, connecting the vapor portion of the chamber to the ambient can reduce the pressure of the chamber, wherein the reduced pressure is configured to generate bubbles at a surface of the object. Disconnecting the connection of the vapor portion of the chamber to the ambient can increase the vapor pressure of the chamber due to the vaporization of the liquid portion of the chamber, wherein the increased pressure is configured to terminate generated bubbles. The superheated liquid can include water at temperature above 100 C. The temperature of the superheated liquid can be between 110 and 200 C. The pressure of the superheated liquid can be between 1 and 20 bars.

In some embodiments, the methods can further include draining a portion of the superheated liquid from the chamber, and then adding a new superheated liquid to the chamber. The methods can also include repeating flowing a superheated liquid and periodically cycling pressure, or repeating flowing a superheated liquid, periodically cycling pressure, and draining the superheated liquid.

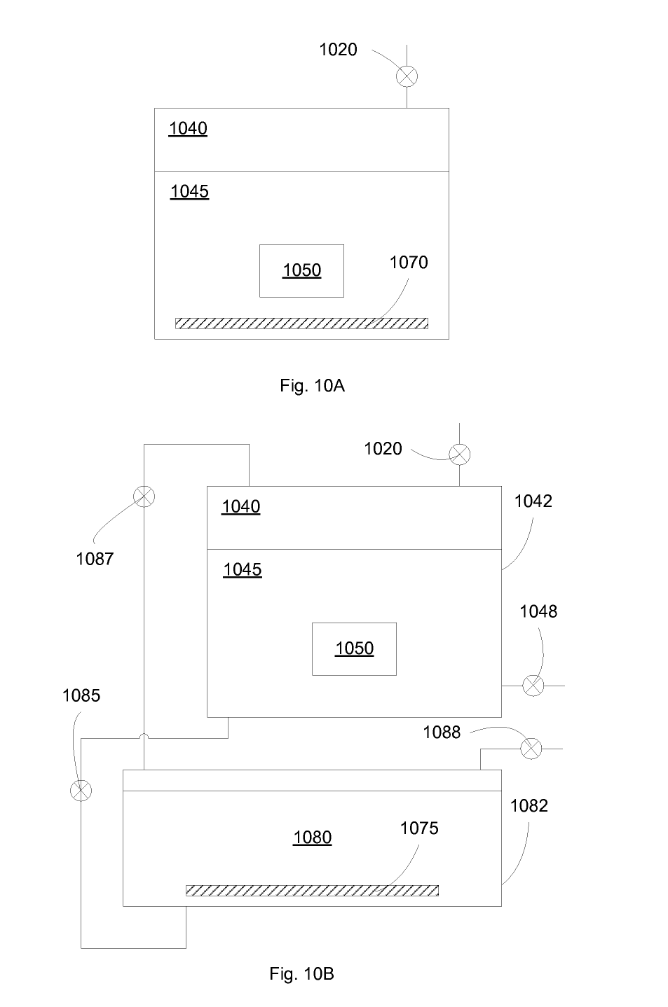

FIGS. 10A-10B illustrate exemplary system configurations for a hyperbaric process according to some embodiments. In FIG. 10A, a chamber containing a liquid 1045, which is partially filled the chamber with an object 1050 submerged in the liquid 1045. A heater 1070 can be included to heat the liquid to a temperature and pressure above atmospheric pressure. A relief valve 1020 is coupled to the chamber to release the chamber pressure. The liquid can be introduced to the chamber, which is then sealed and heated to bring the liquid to a high energy state of high pressure and temperature. Alternatively, a heated liquid can be introduced to the chamber, with the heater maintaining the liquid temperature. Cyclic nucleation process from a hyperbaric pressure can be performed after the heating the liquid, for example, by cycling the relief valve 1020 (e.g., repeating opening and closing). The liquid can be constantly or intermittently heated during the cyclic nucleation process.

In some embodiments, the liquid medium can be supplied to the chamber through a reservoir. The reservoir can be heated to maintain a constant supply of liquid at the proper pressure, e.g., hyperbaric pressure, to the chamber. FIG. 10B shows a reservoir 1082 to supply liquid to a chamber 1042 through a valve 1085. Heater 1075 can be used to heat the liquid 1080 to a pressure above atmospheric pressure. Heater 1075 can be constantly heated to maintain the proper temperature and pressure for the liquid 1080. Valve 1088 can be used to pressurize the reservoir head space. Valve 1085 can be open to deliver the heated liquid to the chamber 1042, submerging the object 1050 within liquid 1045, leaving vapor portion 1040. Valve 1087 can be open to deliver the heated vapor to the vapor 1040 portion of the chamber 1042. A relief valve 1020 can be included to open and close, to perform cyclic nucleation process, cleaning the object 1050 by cycling high pressure to lower values, crossing the boiling curve for generating and terminating bubbles. During the closing of the relief valve 1020, valve 1087 can be open to re-supply the chamber 1042 with new heated vapor from the reservoir 1082. A drain valve 1048 can be included for draining the liquid, for example, when the cleaning process is completed.

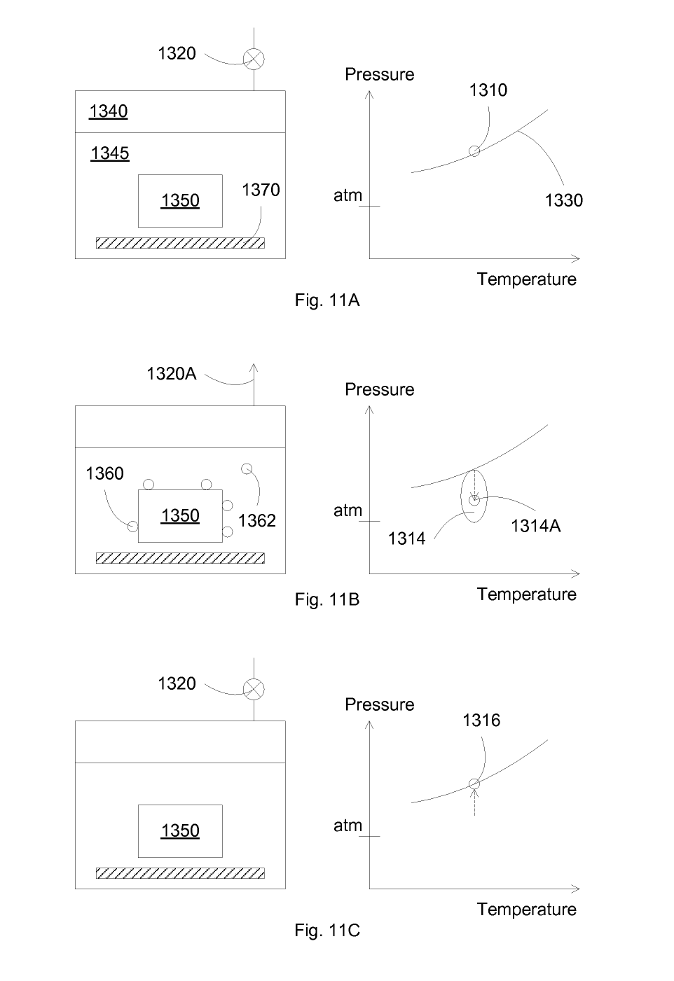

FIGS. 11A-11C illustrate an exemplary cyclic nucleation process at a hyperbaric pressure according to some embodiments. In FIG. 11A, an object 1350 is submerged in a liquid 1345 in a sealed container. The container is preferably partially filled with the liquid 1345, leaving a head space 1340 to accommodate the liquid vapor. A relief valve 1320 is connected to the vapor portion 1340 of the container, which can regulate the pressure in the container. A heater 1370 can be provided to the container to heat the liquid. The liquid can have high internal energy, for example, at a temperature and pressure point 1310 above the boiling curve 1330. The pressure point 1310 is also preferably above the boiling temperature at atmospheric pressure. The liquid pressure is also preferably higher than the atmospheric pressure.

In some embodiments, the liquid comprises water, for example, water or water solutions with dissolved chemicals such as cleaning chemical. In some embodiments, the temperature of the water solutions can be above 100° C., such as between 100 and 200° C. In some embodiments, the pressure of the water solutions can be above atmospheric pressure, such as between 1 and 20 bars.

In some embodiments, the liquid is at the boiling curve, meaning the pressure 1340 at the head space above the liquid surface is the vapor pressure of the liquid 1345 at the liquid temperature. This condition can be achieved by heating the liquid. As the temperature of the liquid increases, more liquid vapor is generated to move the pressure along the boiling curve.

In FIG. 11B, the relief valve 1320 is open (shown in open state 1320A) to atmosphere. In some embodiments, the pressure is reduced, for example, by releasing the vapor 1340. With adequate drop in pressure, the liquid can initiate boiling, e.g., bubbles 1360 can start forming at the surface of the object. For example, the pressure of the container can be dropped to a point 1314A below the boiling curve 1330, thus boiling the liquid. The point 1314A can be within the operating region 1314, which can be at or below the boiling curve. The drop in pressure is preferably regulated to optimize the cleaning or surface treatment process, for example, to maximize bubble 1360 generation at the surface of the object and minimize bubbles 1362 formation within the liquid. For example, the relief valve 1320 can be a control valve, allowing a specific opening to the exit.

In FIG. 11C, the pressure can start increasing to pressure 1316, which can be about the boiling curve, thus stopping the boiling process, terminating the bubbles 1360 to generate a surface effect.

In some embodiments, the relief valve 1320 is close, and the pressure can start increasing to an equilibrium pressure, for example, the heater can heat the liquid to increase the vapor pressure to reach equilibrium. The pressure 1316 is generally at about the boiling pressure, since it is the equilibrium pressure due to the vaporization of the liquid. The temperature can be higher or lower, depending on the heater conditions. For example, significant additional heating when the relief valve is close can increase the temperature of the liquid. The process can be repeated until the object is cleaned and/or processed.

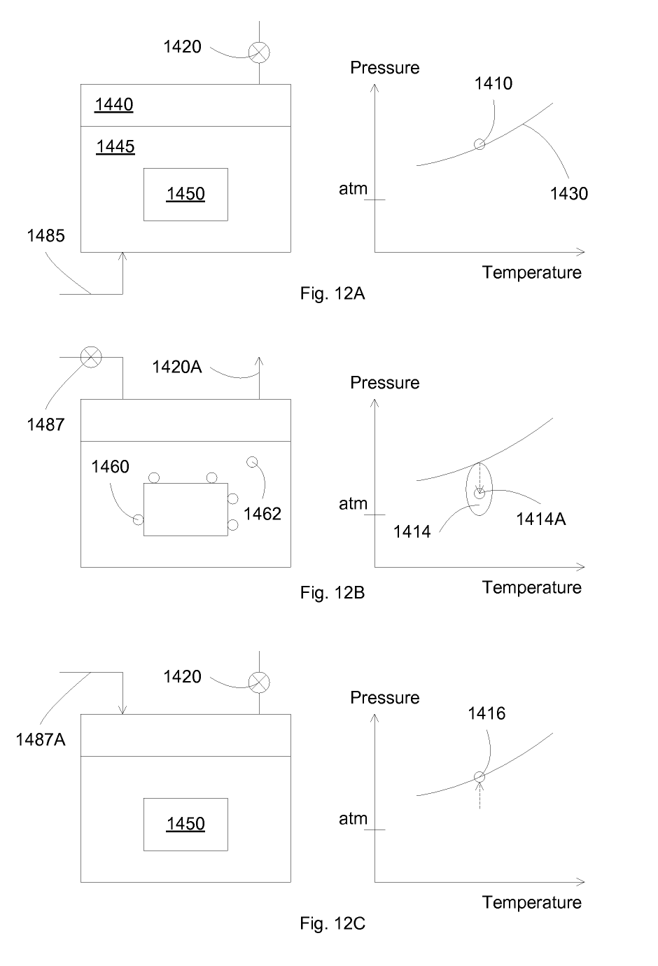

FIGS. 12A-12C illustrate another exemplary cyclic nucleation process at a hyperbaric pressure according to some embodiments. In FIG. 12A, an object 1450 is submerged in a liquid 1445 in a sealed container. The container is preferably partially filled with the liquid 1445, leaving a head space 1440 to accommodate the liquid vapor. The liquid 1445 can be provided through conduit 1486, for example, from a reservoir 582. A relief valve 1420 is connected to the vapor portion 1440 of the container, which can regulate the pressure in the container. A heater 1470 can be provided to the container to heat the liquid. The liquid can have high internal energy, for example, at a temperature and pressure point 1410 above the boiling curve 1430. The pressure point 1410 is also preferably above atmospheric pressure.

In FIG. 12B, the relief valve 1420 is open (shown in open state 1420A) to reduce pressure. In some embodiments, the pressure is reduced, for example, by releasing the vapor 1440. With adequate drop in pressure, the liquid can initiate boiling, e.g., bubbles 1460 can start forming at the surface of the object. For example, the pressure of the container can be dropped to a point 1414A below the boiling curve 1430, thus boiling the liquid. The point 1414A can be within the operating region 1414, which can be at or below the boiling curve. The drop in pressure is preferably regulated to optimize the cleaning or treatment process, for example, to maximize bubble 1460 generation at the surface of the object and minimize bubbles 1462 formation within the liquid. For example, the relief valve 1420 can be a control valve, allowing a specific opening to the exit.

In FIG. 12C, the pressure can start increasing to pressure 1416, which can be about the boiling curve, thus stopping the boiling process, terminating the bubbles 1460 to generate a surface cleaning effect. In some embodiments, the relief valve 1420 is close, and the valve 1487 is open (valve state 1487A) to deliver heated vapor to the chamber. For example, valve 1487 can be coupled to a reservoir 582 for delivering saturated vapor. The pressure 1416 is generally at about the boiling pressure, since it is the equilibrium pressure due to the vaporization of the liquid in the reservoir. The process can be repeated until the object is cleaned.

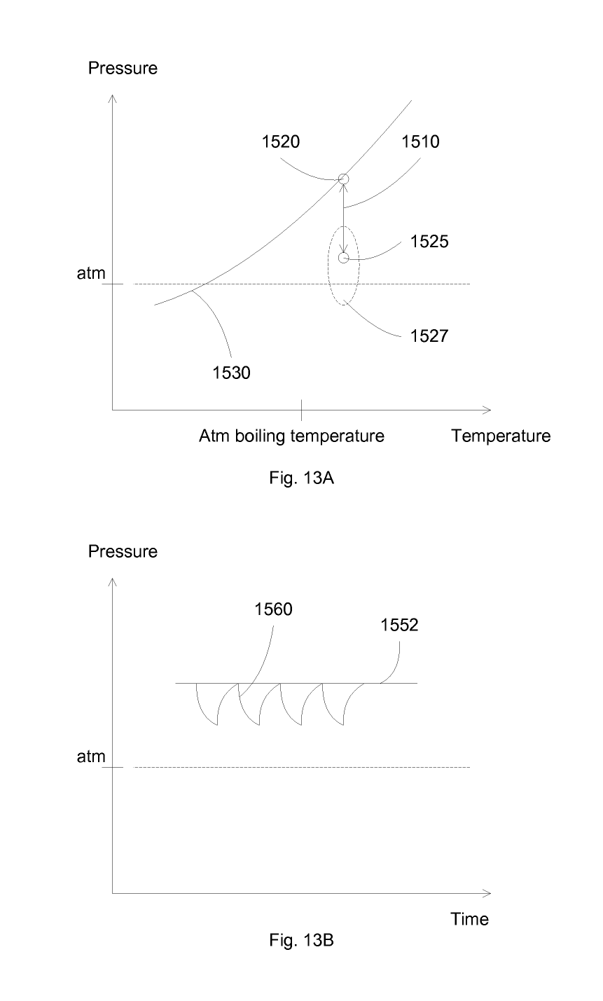

FIGS. 13A-13B illustrates exemplary pressure flows for a hyperbaric process according to some embodiments. In FIG. 13A, the container pressure is cycled 1510 across the boiling curve 1530, for example, between the high pressure 1520 and the low pressure 1525 (in operating region 1527). The low pressure 1525 is preferably also above atmospheric pressure, but in some embodiments, below atmospheric pressure can be used. In FIG. 13B, the pressure cycling 1560 can be oscillated under the boiling curve 1552, which can be constant with time due to the added energy from either the heater or from the heated vapor from the reservoir. For example, without adequate added energy, the container pressure can be oscillated but temperature and corresponding pressure are reduced slightly with each pressure cycle as energy is released. With adequate added energy, constant temperature can be maintained or even increased as pressure is cycled. For a well-insulated container, the temperature can be somewhat constant, and the pressure range can be held constant over repeated pressure cycles. The above explanation is oversimplified, and is not meant to limit the scope and validity of the present invention, which is defined by the enclosed claims.

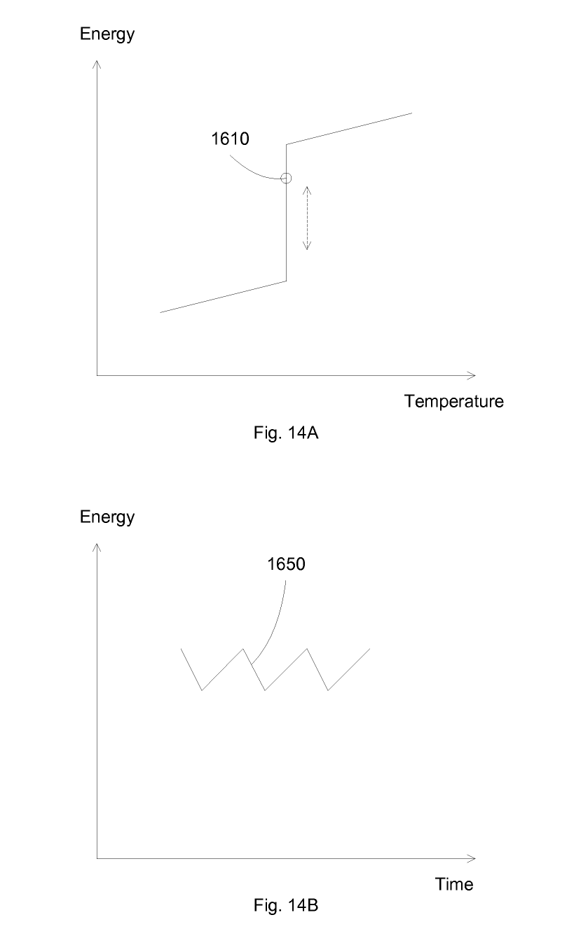

FIGS. 14A-14B illustrates exemplary energy flows for a hyperbaric process according to some embodiments. In FIG. 14A, the internal energy of the liquid is reduced along the vapor-liquid transition section, for example, from a high energy 1610 to lower energies. The curve shown is exemplary, and can be drift to lower temperature due to loss of temperature. In FIG. 14B, the energy 1650 is shown to be oscillated with time, due to the pressure addition and release. Alternatively, with different added pressure and/or heat, the energy can be increased or decreased, e.g., gaining or dropping energy during the cycling.

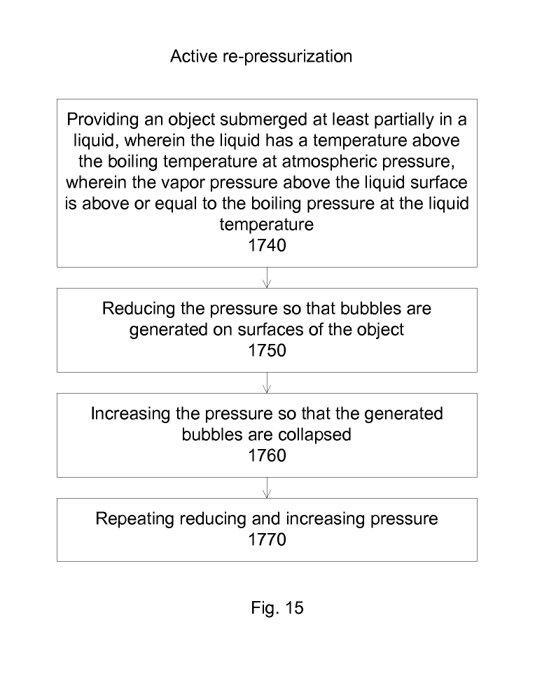

FIG. 15 illustrates an exemplary flow chart for a hyperbaric cyclic nucleation process according to some embodiments. Operation 1740 provides an object submerged at least partially in a liquid, wherein the liquid has a temperature above the boiling temperature at atmospheric pressure, wherein the vapor pressure above the liquid surface is above or equal to the boiling pressure at the liquid temperature. Operation 1750 reduces the pressure so that bubbles are generated on surfaces of the object. Operation 1760 increases the pressure so that the generated bubbles are collapsed. Operation 1770 repeats the steps of reducing and increasing pressure, for example, until the object is cleaned and/or processed.

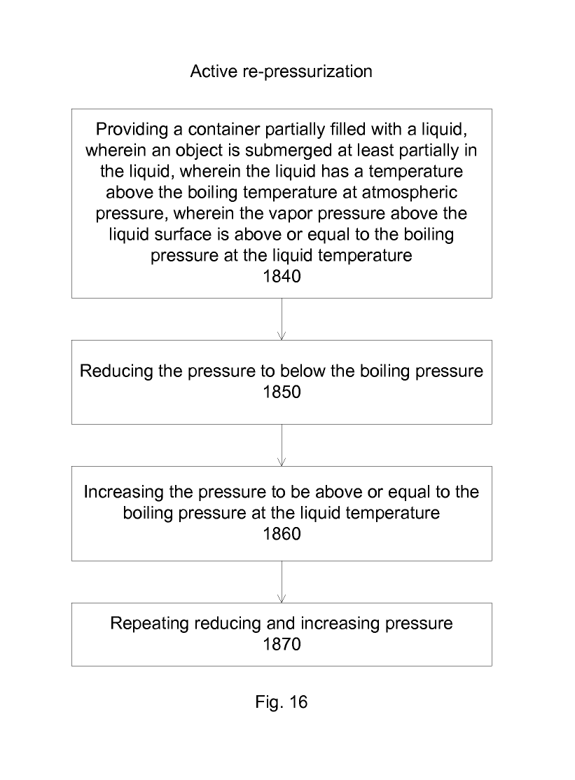

FIG. 16 illustrates another exemplary flow chart for a hyperbaric cyclic nucleation process according to some embodiments. Operation 1840 provides a container partially filled with a liquid, wherein an object is submerged at least partially in the liquid, wherein the liquid has a temperature above the boiling temperature at atmospheric pressure, wherein the vapor pressure above the liquid surface is above or equal to the boiling pressure corresponded to the liquid temperature. Operation 1850 reduces the pressure to below the boiling pressure. Operation 1860 increases the pressure to be above or equal to the boiling pressure at the liquid temperature. Operation 1870 repeats the steps of reducing and increasing pressure.

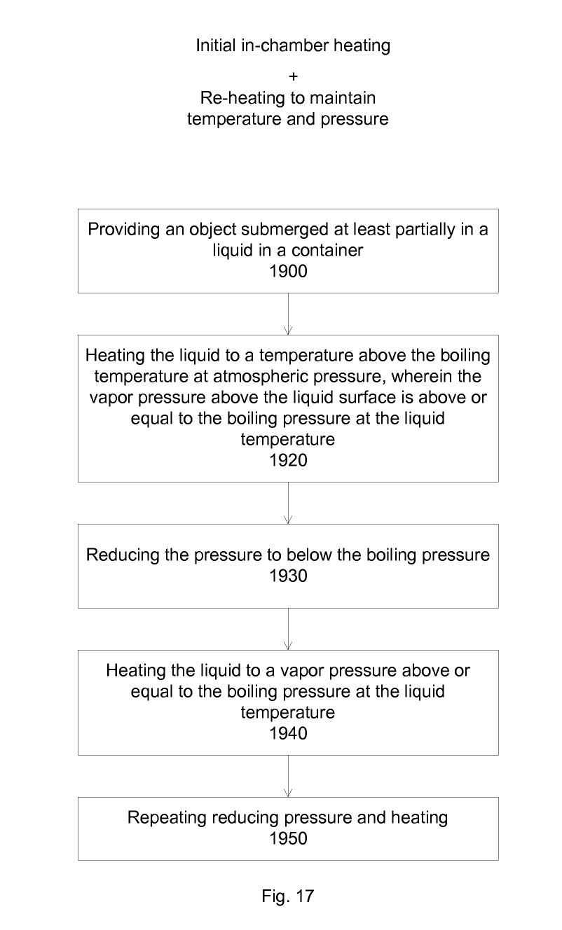

FIG. 17 illustrates another exemplary flow chart for a hyperbaric cyclic nucleation process according to some embodiments. Operation 1900 provides an object submerged at least partially in a liquid in a container. Operation 1910 heats the liquid to a temperature above the boiling temperature at atmospheric pressure, wherein the vapor pressure above the liquid surface is above or equal to the boiling pressure at the liquid temperature. Operation 1920 reduces the vapor pressure to below the boiling pressure. Operation 1930 heats the liquid to a vapor pressure above or equal to the boiling pressure at the liquid temperature. Operation 1940 repeats the steps of reducing pressure and heating the liquid.

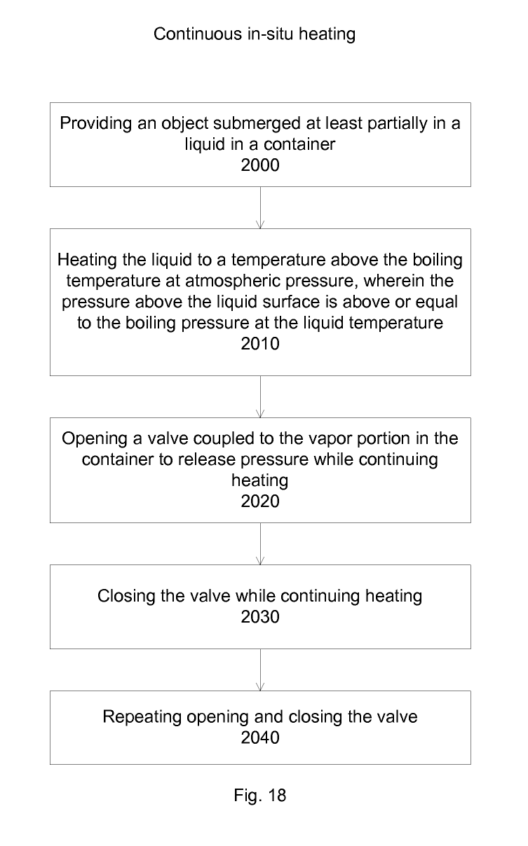

FIG. 18 illustrates another exemplary flow chart for a hyperbaric cyclic nucleation process according to some embodiments. Operation 2000 provides an object submerged at least partially in a liquid in a container. Operation 2010 heats the liquid to a temperature above the boiling temperature at atmospheric pressure, wherein the vapor pressure above the liquid surface is above or equal to the boiling pressure at the liquid temperature. Operation 2020 opens a valve coupled to the vapor portion of the container to release the vapor while continuing heating. Operation 2030 closes the valve while continuing heating. Operation 2040 repeats opening and closing the valve.

In an exemplary process, the process chamber is filled with liquid from the reservoir. Pressure is then cycled, for example, released for the formation of bubbles and increased for the termination of bubbles. The liquid can be drained and replaced with new liquid from the reservoir, and the cleaning/processing cycle is repeated. After complete cleaning/processing, the liquid can be drained.

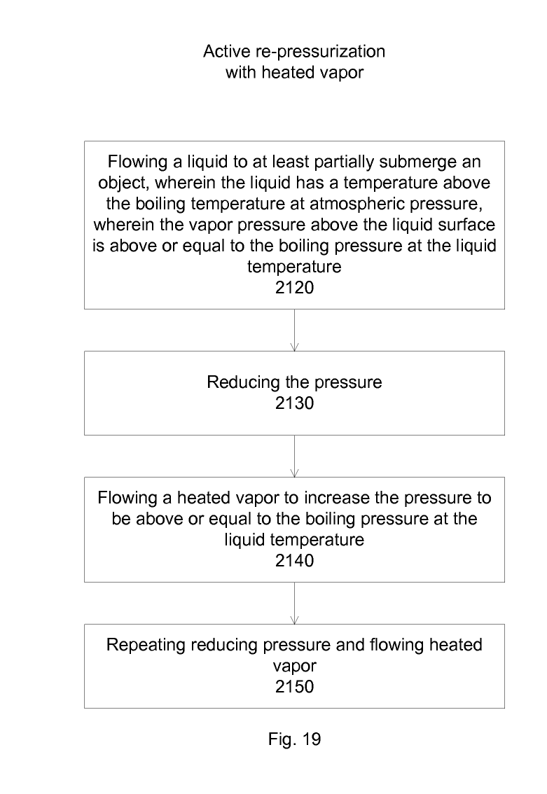

FIG. 19 illustrates another exemplary flow chart for a hyperbaric cyclic nucleation process according to some embodiments. Operation 2120 flows a liquid to the container to at least partially submerge the object, wherein the liquid has a temperature above the boiling temperature at atmospheric pressure, wherein the vapor pressure above the liquid surface is above or equal to the boiling pressure at the liquid temperature. Operation 2130 reduces the pressure. Operation 2140 adds a heated vapor to increase the pressure to be above or equal to the boiling pressure at the liquid temperature. Operation 2150 repeats reducing pressure and flowing heated vapor, for example, until the object is cleaned and/or processed.

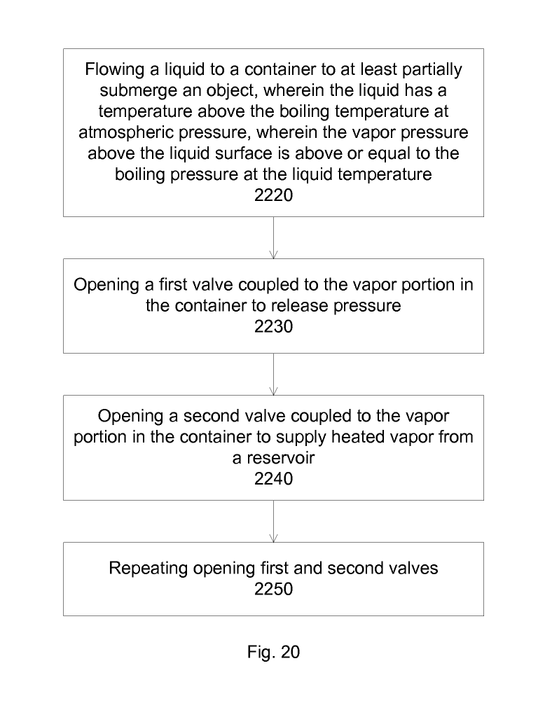

FIG. 20 illustrates another exemplary flow chart for a hyperbaric cyclic nucleation process according to some embodiments. Operation 2220 flows a liquid to the container to at least partially submerge the object, wherein the liquid has a temperature above the boiling temperature at atmospheric pressure, wherein the vapor pressure above the liquid surface is above or equal to the boiling pressure at the liquid temperature. Operation 2230 opens a first valve coupled to the vapor portion in the container to release the pressure. Operation 2340 opens a second valve to supply heated vapor to the container from a reservoir. The first valve can be close before opening the second valve. A three way valve can be used. The second valve can be closed after reaching a desired pressure. Operation 2250 repeats cycling the first and second valves, for example, until the object is cleaned.

Other configurations can be used. For example, the pressure can gradually decrease, which can lead to more and more bubbles nucleated at the object surface with minimum bubbles formed within the liquid. The pressure can decrease to a value above atmospheric pressure, above atmospheric pressure, or below atmospheric pressure. Thus the pressure can cycle at two values of pressure wherein both of these values are above atmospheric pressure. Alternatively, the pressure can cycle from an above atmospheric pressure to about atmospheric pressure. Alternatively, the pressure can cycle from an above atmospheric pressure to below atmospheric pressure.

In some embodiments, cleaning methods using hyperbaric pressure are provided. The method can include providing an object in a chamber; flowing a superheated liquid to the chamber to at least partially submerge the object, wherein the superheated liquid has a temperature above the boiling temperature at atmospheric pressure, wherein the superheated liquid partially fills the chamber so that the chamber comprises a liquid portion and a vapor portion. The methods can include repeatedly connecting the vapor portion of the chamber to an ambient, wherein the ambient has lower vapor pressure than the chamber; and then connecting the vapor portion of the chamber to a vapor portion of a reservoir, wherein the reservoir comprises a superheated liquid.

In some embodiments, connecting the vapor portion of the chamber to the ambient can reduce the vapor pressure of the chamber by releasing the vapor pressure of the chamber. Connecting the vapor portion of the chamber to the vapor portion of the reservoir can increase the vapor pressure of the chamber by supplying a superheated vapor to the chamber. The superheated liquid can include water at temperature above 100 C. The temperature of the superheated liquid can be between 110 and 200 C. The pressure of the superheated liquid can be between 1 and 20 bars.

In some embodiments, the methods can further include heating the superheated liquid in the reservoir to a temperature at or above the temperature of the superheated in the chamber.

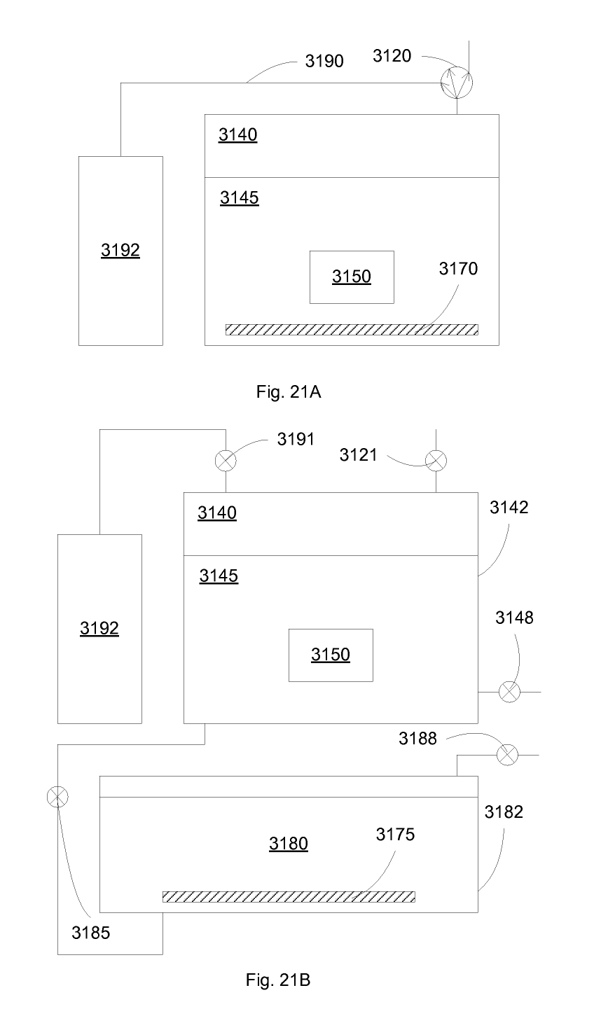

FIGS. 21A-21B illustrate exemplary system configurations for a hyperbaric process according to some embodiments. In FIG. 21A, a chamber containing a liquid 3145, which is partially filled the chamber with an object 3150 submerged in the liquid 3145. A heater 3170 can be included to heat the liquid to a temperature and pressure above atmospheric pressure. A pressurized container 3192 can be coupled to the chamber to provide pressurized gas or vapor to the chamber. The pressurized container 3192 can be a gas cylinder comprising compressed gas, or a container containing superheated steam. The pressurized container 3192 can be coupled to the chamber through a three-way relief valve 3120, also for releasing the chamber pressure. The liquid can be introduced to the chamber, which is then sealed and heated to bring the liquid to a high energy state of high pressure and temperature. Alternatively, a heated liquid can be introduced to the chamber, with the heater maintaining the liquid temperature. Cyclic nucleation process from a hyperbaric pressure can be performed after the heating the liquid, for example, by cycling the relief valve 3120 (e.g., repeating venting to atmosphere, closing, and pressurizing from the pressurized container 3192). The liquid can be constantly or intermittently heating during the cyclic nucleation process.

In some embodiments, the liquid medium can be supplied to the chamber through a reservoir. The reservoir can be heated to maintain a constant supply of liquid at the proper pressure, e.g., hyperbaric pressure, to the chamber. FIG. 21B shows a reservoir 3182 to supply liquid to a chamber 3142 through a valve 3185. Heater 3175 can be used to heat the liquid 3180 to a pressure above atmospheric pressure. Heater 3175 can be constantly heated to maintain the proper temperature and pressure for the liquid 3180. Valve 3188 can be used to pressurize the reservoir head space. Valve 3185 can be open to deliver the heated liquid to the chamber 3142, submerging the object 3150 within liquid 3145, leaving vapor portion 3140. Valve 3191 can be included to deliver the pressurized gas or vapor from a pressurized container 3192 to the vapor 3140 portion of the chamber 3142. A relief valve 3120 can be included to open and close, to perform cyclic nucleation process, cleaning the object 3150 by cycling high pressure to lower values, crossing the boiling curve for generating and terminating bubbles. Valve 3191 and relief valve 3121 can be combined to form a three way valve, e.g., valve 3120. During the closing of the relief valve 3121, valve 3191 can be open to re-supply the chamber 3142 with new heated vapor from the container 3192. A drain valve 3148 can be included for draining the liquid, for example, when the cleaning process is completed.

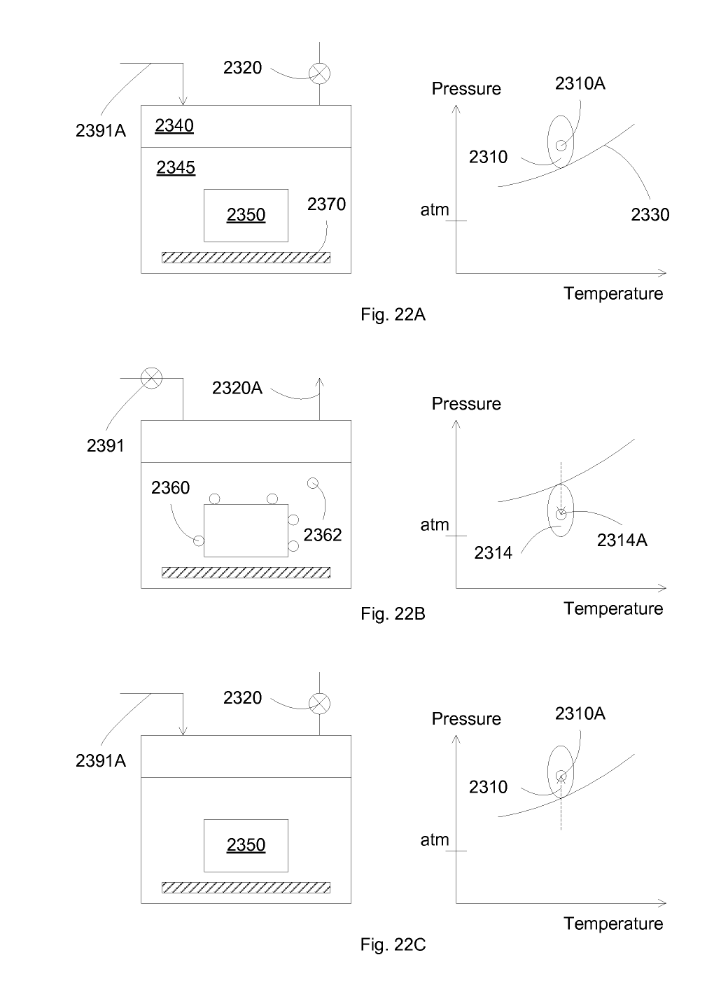

FIGS. 22A-22C illustrate an exemplary cyclic nucleation process at a hyperbaric pressure according to some embodiments. In FIG. 22A, an object 2350 is submerged in a liquid 2345 in a sealed container. The container is preferably partially filled with the liquid 2345, leaving a head space 2340 to accommodate the liquid vapor. A conduit 2391A is coupled to the chamber, for example, to pressurize the chamber. The conduit 2391A can be provided from a pressurized container, such as container 592. A relief valve 2320 is connected to the vapor portion 2340 of the container, which can regulate the pressure in the container. A heater 2370 can be provided to the container to heat the liquid. The liquid can have high internal energy, for example, at a temperature and pressure point 2310A (somewhere in operating region 2310) above the boiling curve 2330. The operating region 2310 and pressure point 2310A are also preferably above the boiling temperature at atmospheric pressure. The liquid pressure is also preferably higher than the atmospheric pressure.

In some embodiments, the liquid comprises water, for example, water or water solutions with dissolved chemicals such as cleaning chemical. In some embodiments, the temperature of the water solutions can be above 100° C., such as between 100 and 200° C. In some embodiments, the pressure of the water solutions can be above atmospheric pressure, such as between 1 and 20 bars.

In some embodiments, the liquid is at the boiling curve, meaning the pressure 2340 at the head space above the liquid surface is the vapor pressure of the liquid 2345 at the liquid temperature. This condition can be achieved by heating the liquid. As the temperature of the liquid increases, more liquid vapor is generated to move the pressure along the boiling curve.

In FIG. 22B, the relief valve 2320 is open (shown in open state 2320A) to atmosphere. The inlet valve 2391, which provide additional pressure to the chamber, is close. In some embodiments, the pressure is reduced, for example, by releasing the vapor 2340. With adequate drop in pressure, the liquid can initiate boiling, e.g., bubbles 2360 can start forming at the surface of the object. For example, the pressure of the container can be dropped to a point 2314A below the boiling curve 2330, thus boiling the liquid. The point 2314A can be within the operating region 2314, which can be at or below the boiling curve. The drop in pressure is preferably regulated to optimize the process, for example, to maximize bubble 2360 generation at the surface of the object and minimize bubbles 2362 formation within the liquid. For example, the relief valve 2320 can be a control valve, allowing a specific opening to the exit.

In FIG. 22C, the pressure can start increasing to pressure 2310, which can be about the boiling curve, thus stopping the boiling process, terminating the bubbles 2360 to generate a surface effect.

In some embodiments, the relief valve 2320 is closed, and the pressure can start increasing, for example, the heater can heat the liquid to increase the vapor pressure to reach equilibrium or valve 2391 is open to allow conduit 2391A to supply pressurized gas or heated vapor (e.g., saturated or heated steam) to the chamber. The pressure 2310 can be at about or above the boiling pressure. The temperature can be higher or lower, depending on the heater conditions. For example, significant additional heating when the relief valve is close can increase the temperature of the liquid. The process can be repeated until the object is cleaned.

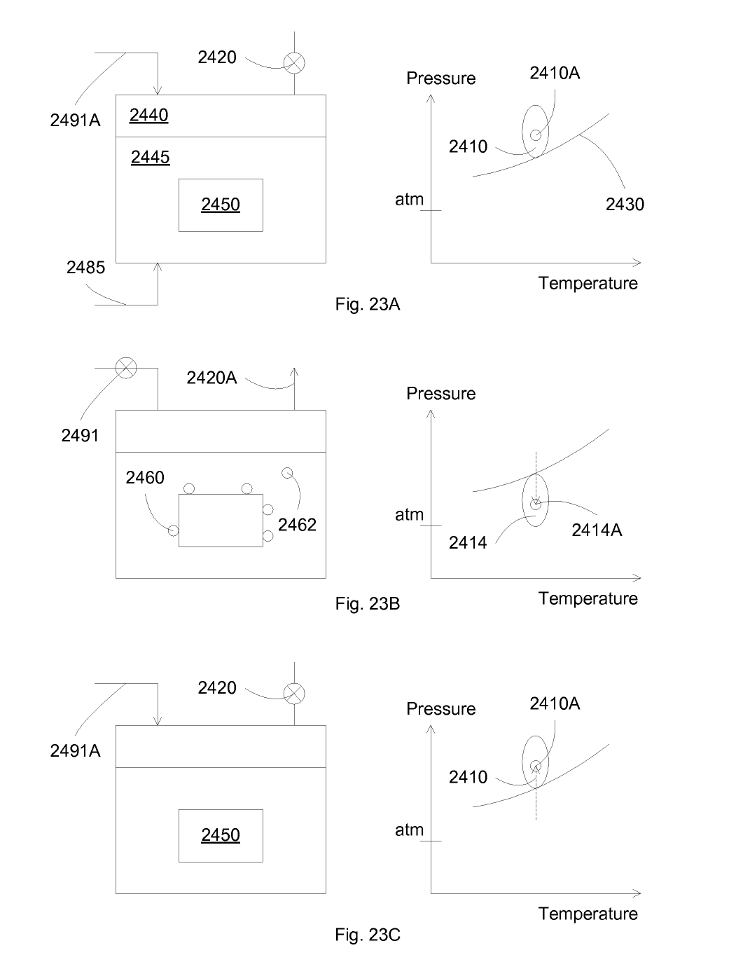

FIGS. 23A-23C illustrate another exemplary cyclic nucleation process at a hyperbaric pressure according to some embodiments. In FIG. 23A, an object 2450 is submerged in a liquid 2445 in a sealed container. The container is preferably partially filled with the liquid 2445, leaving a head space 2440 to accommodate the liquid vapor. The liquid 2445 can be provided through conduit 2485, for example, from a reservoir 582. A conduit 2491A is coupled to the chamber, for example, to pressurize the chamber. The conduit 2491A can be provided from a pressurized container, such as container 592. A relief valve 2420 is connected to the vapor portion 2440 of the container, which can regulate the pressure in the container. A heater 2370 can be provided to the container to heat the liquid. The liquid can have high internal energy, for example, at a temperature and pressure point 2410A (somewhere in operating region 2410) above the boiling curve 2430. The operating region 2410 and the pressure point 2410A are also preferably above the boiling temperature at atmospheric pressure. The liquid pressure is also preferably higher than the atmospheric pressure.

In FIG. 23B, the relief valve 2420 is open (shown in open state 2420A) to atmosphere. The inlet valve 2491, which provide additional pressure to the chamber, is close. In some embodiments, the pressure is reduced, for example, by releasing the vapor 2440. With adequate drop in pressure, the liquid can initiate boiling, e.g., bubbles 2460 can start forming at the surface of the object. For example, the pressure of the container can be dropped to a point 2414A below the boiling curve 2430, thus boiling the liquid. The point 2414A can be within the operating region 2414, which can be at or below the boiling curve. The drop in pressure is preferably regulated to optimize the process, for example, to maximize bubble 2460 generation at the surface of the object and minimize bubbles 2462 formation within the liquid. For example, the relief valve 2420 can be a control valve, allowing a specific opening to the exit.

In FIG. 23C, the pressure can start increasing to pressure 2410A, which can be about the boiling curve, thus stopping the boiling process, terminating the bubbles 2460 to generate a surface cleaning effect. In some embodiments, the relief valve 2420 is close, and the valve 2491 is open (valve state 2491A) to deliver pressurized gas or heated vapor to the chamber. For example, valve 2491 can be coupled to a reservoir 582 for delivering saturated vapor, or from a pressurized container 592 to deliver superheated steam or pressurized gas. The pressure 2410A is generally at about or above the boiling pressure. The process can be repeated until the object is cleaned or processed.

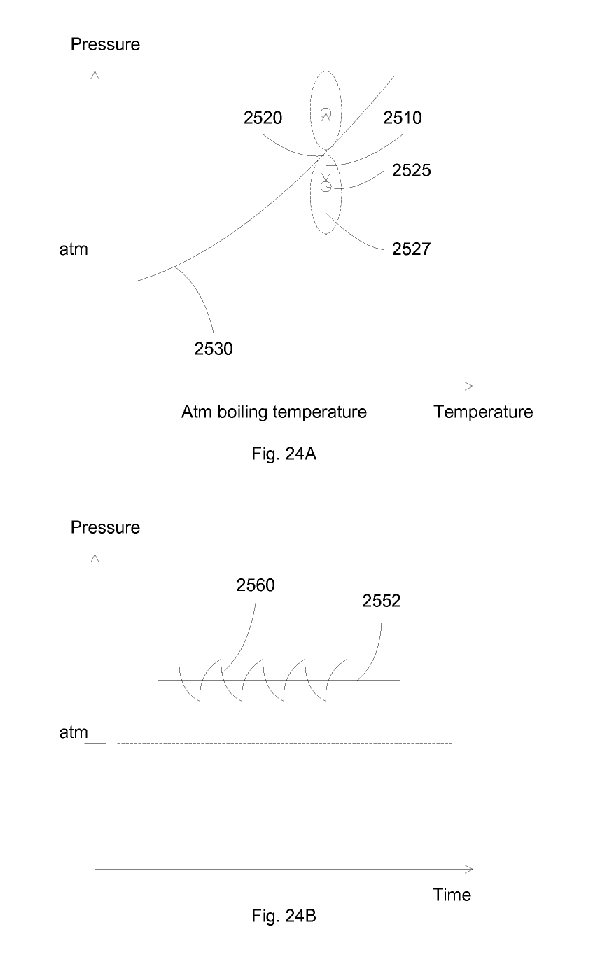

FIGS. 24A-24B illustrates exemplary pressure flows for a hyperbaric process according to some embodiments. In FIG. 24A, the container pressure is cycled 2510 across the boiling curve 2530, for example, between the high pressure 2520 and the low pressure 2525 (in operating region 2527). The low pressure 2525 is preferably also above atmospheric pressure, but in some embodiments, below atmospheric pressure can be used. In FIG. 24B, the pressure cycling 2560 can be oscillated under the boiling curve 2552, which can be constant with time due to the added energy from either the heater or from the heated vapor from the reservoir. For example, without adequate added energy, the container pressure can be oscillated below the boiling curve. With adequate added energy, it can rise at or above the boiling curve. For a well-insulated container, the temperature can be somewhat constant, and the boiling pressure can be constant with time. The above explanation is oversimplified, and is not meant to limit the scope and validity of the present invention, which is defined by the enclosed claims.

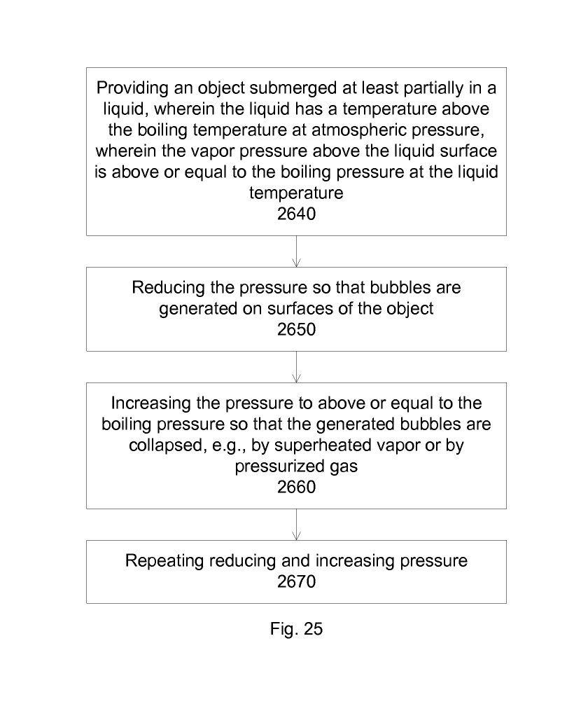

FIG. 25 illustrates an exemplary flow chart for a hyperbaric cyclic nucleation process according to some embodiments. Operation 2640 provides an object submerged at least partially in a liquid, wherein the liquid has a temperature above the boiling temperature at atmospheric pressure, wherein the vapor pressure above the liquid surface is above or equal to the boiling pressure at the liquid temperature. Operation 2650 reduces the pressure so that bubbles are generated on surfaces of the object. Operation 2660 increases the pressure to above or equal to the boiling pressure, e.g., by pressurized gas or superheated steam, so that the generated bubbles are collapsed. Operation 2670 repeats the steps of reducing and increasing pressure, for example, until the object is cleaned or processed.

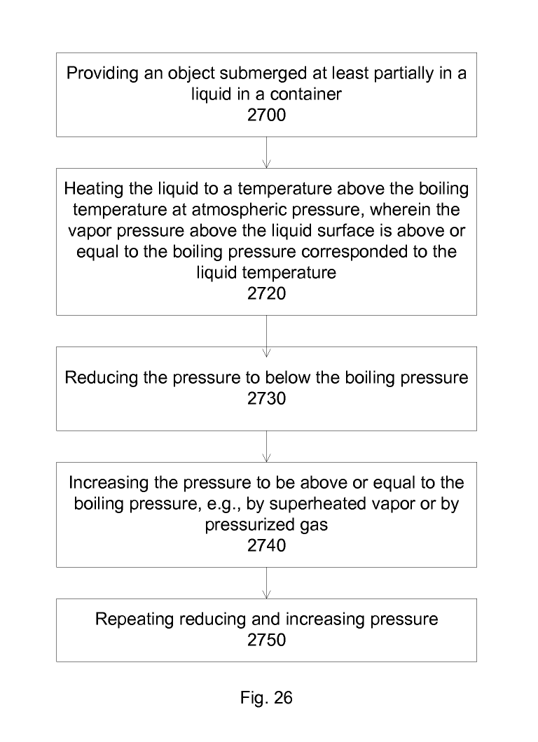

FIG. 26 illustrates another exemplary flow chart for a hyperbaric cyclic nucleation process according to some embodiments. Operation 2700 provides an object submerged at least partially in a liquid in a container. Operation 2720 heats the liquid to a temperature above the boiling temperature at atmospheric pressure, wherein the vapor pressure above the liquid surface is above or equal to the boiling pressure at the liquid temperature. Operation 2730 reduces the pressure to below the boiling pressure. Operation 2740 increases the pressure to be above or equal to the boiling pressure at the liquid temperature, e.g., by pressurized gas or superheated steam. Operation 2750 repeats the steps of reducing and increasing pressure.

In an exemplary process, the process chamber is filled with liquid from the reservoir. Pressure is then cycled, for example, released for the formation of bubbles and increased for the termination of bubbles. The liquid can be drained and replaced with new liquid from the reservoir, and the cleaning and/or surface processing cycle is repeated. After complete cleaning/processing, the liquid can be drained.

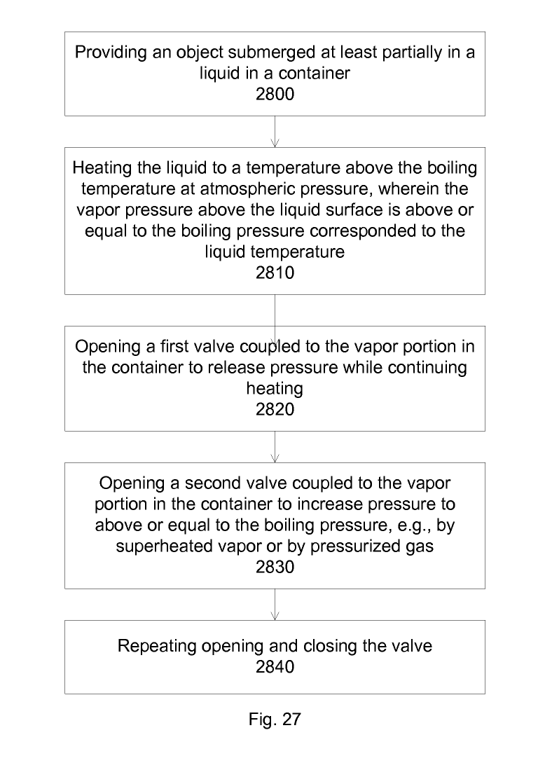

FIG. 27 illustrates another exemplary flow chart for a hyperbaric cyclic nucleation process according to some embodiments. Operation 2800 provides an object submerged at least partially in a liquid in a container. Operation 2810 heats the liquid to a temperature above the boiling temperature at atmospheric pressure, wherein the vapor pressure above the liquid surface is above or equal to the boiling pressure at the liquid temperature. Operation 2820 opens a first valve coupled to the vapor portion in the container to release the pressure. Operation 2830 opens a second valve to supply heated vapor to the container from a reservoir, e.g., by pressurized gas or superheated steam. The first valve can be close before opening the second valve. A three way valve can be used. The second valve can be close after reaching a desired pressure. Operation 2840 repeats cycling the first and second valves, for example, until the object is cleaned/processed.

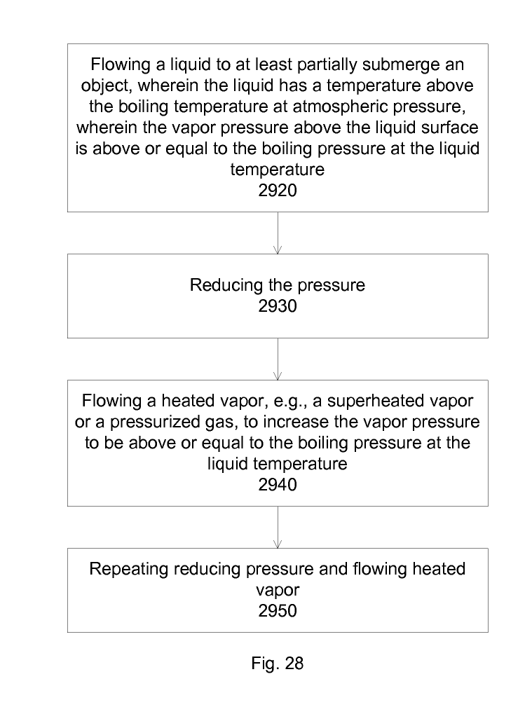

FIG. 28 illustrates another exemplary flow chart for a hyperbaric cyclic nucleation process according to some embodiments. Operation 2920 flows a liquid to the container to at least partially submerge the object, wherein the liquid has a temperature above the boiling temperature at atmospheric pressure, wherein the vapor pressure above the liquid surface is above or equal to the boiling pressure at the liquid temperature. Operation 2930 reduces the pressure. Operation 2940 flows a heated vapor to increase the pressure to be above or equal to the boiling pressure at the liquid temperature, e.g., by pressurized gas or superheated steam. Operation 2950 repeats reducing pressure and flowing heated vapor, for example, until the object is cleaned/processed.

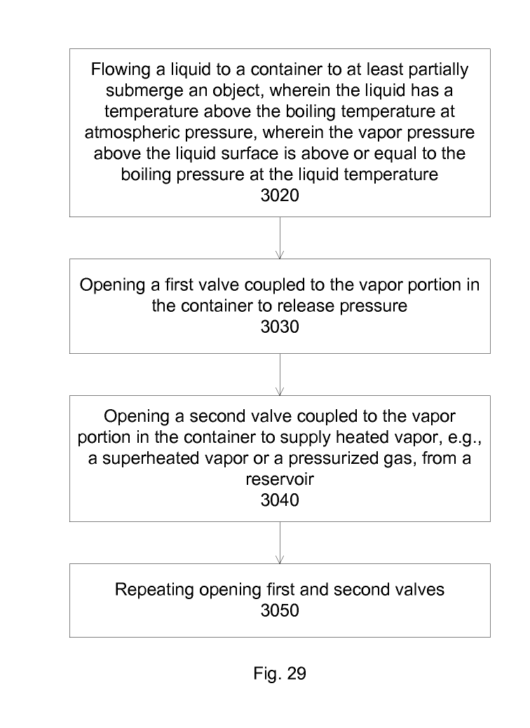

FIG. 29 illustrates another exemplary flow chart for a hyperbaric cyclic nucleation process according to some embodiments. Operation 3020 flows a liquid to the container to at least partially submerge the object, wherein the liquid has a temperature above the boiling temperature at atmospheric pressure, wherein the vapor pressure above the liquid surface is above or equal to the boiling pressure at the liquid temperature. Operation 3030 opens a first valve coupled to the vapor portion in the container to release the pressure. Operation 3040 opens a second valve to supply heated vapor to the container from a reservoir, e.g., by pressurized gas or superheated steam. The first valve can be closed before opening the second valve. A three way valve can be used. The second valve can be close after reaching a desired pressure. Operation 3050 repeats cycling the first and second valves, for example, until the object is cleaned and/or processed.

Other configurations can be used. For example, the pressure can gradually decrease, which can lead to more and more bubbles nucleated at the object surface with minimum bubbles formed within the liquid. The pressure can decrease to a value above atmospheric pressure, atmospheric pressure, or below atmospheric pressure. Thus the pressure can cycle at two values of pressure wherein both of these values are above atmospheric pressure. Alternatively, the pressure can cycle from above atmospheric pressure to an about atmospheric pressure. Alternatively, the pressure can cycle from an above atmospheric pressure to a below atmospheric pressure.

In some embodiments, cleaning methods using hyperbaric pressure are provided. The methods can include providing an object in a chamber; flowing a superheated liquid to the chamber to at least partially submerge the object, wherein the superheated liquid has a temperature above the boiling temperature at atmospheric pressure, wherein the superheated liquid partially fills the chamber so that the chamber comprises a liquid portion and a vapor portion. The methods can further include repeatedly connecting the vapor portion of the chamber to an ambient, wherein the ambient has lower vapor pressure than the chamber; and then connecting the vapor portion of the chamber to a heated vapor or heated gas.

In some embodiments, connecting the vapor portion of the chamber to the ambient can reduce the vapor pressure of the chamber by releasing the vapor pressure of the chamber. Connecting the vapor portion of the chamber to the vapor portion of the reservoir can increase the vapor pressure of the chamber by supplying a superheated vapor to the chamber. The superheated liquid can include water at temperature above 100 C. The temperature of the superheated liquid can be between 110 and 200 C. The pressure of the superheated liquid can be between 1 and 20 bars.

In some embodiments, the methods can further include heating the superheated liquid in the reservoir to a temperature at or above the temperature of the superheated in the chamber.

In some embodiments, the present invention discloses methods and apparatuses for drying object, comprising releasing high pressure and temperature vapor. During the release of high pressure and temperature vapor, energy can be absorbed. Rapidly expanding vapors can displace liquid droplets and otherwise vaporize any liquid vapor adhering to the object surface, effectively drying the object. This method is called “Rapid Displacement Drying”.

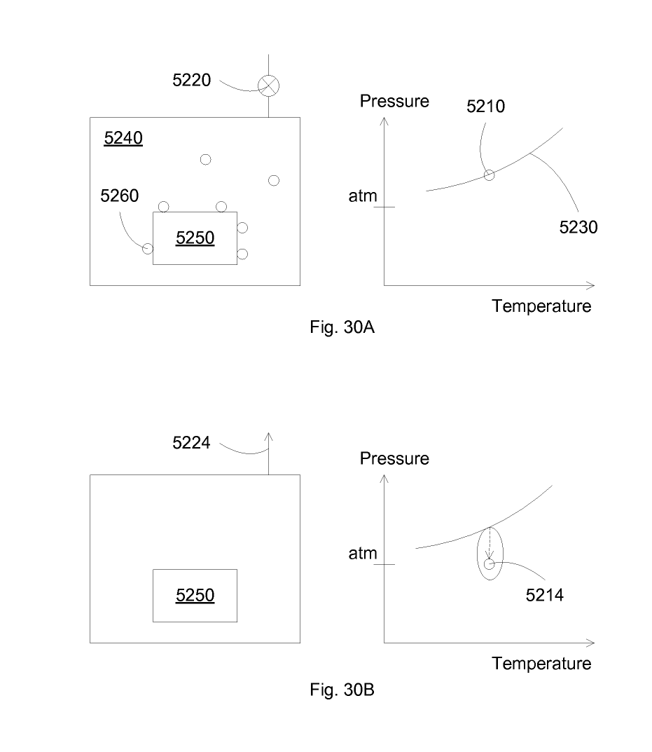

FIGS. 30A-30B illustrate an exemplary cleaning and drying process utilizing hyperbaric vapor pressure according to some embodiments. In FIG. 30A, an object 5250 is disposed in a chamber 5240, which is filled with high pressure and temperature vapor 5260. Valve 5220 is closed to maintain high pressure within the chamber 5240. The vapor 5260 has pressure at or above the boiling pressure corresponded to its liquid temperature, e.g., having temperature-pressure state 5210 at or above the boiling curve 5230. For example, saturated steam can be at the boiling curve, while superheated steam can have pressure above the boiling curve pressure. In addition, the pressure of the vapor 5260 is preferably above atmospheric pressure. For example, the vapor 5260 can be water vapor, e.g., steam, at pressure 5 bars and temperature 160° C. During the exposure to the high energy vapor 5260, the object can be cleaned, for example, sterilized due to the high temperature vapor. The chamber is shown to be without any liquid, but in some embodiments, liquid can be present and also liquid droplets may be present at the surface of the object.

In FIG. 30B, valve 5220 is quickly open (shown by valve state 5224), releasing the vapor 5260 to the ambient, e.g., atmospheric environment. The vapor state 5214 can be dropped to atmospheric pressure below the boiling curve, and any liquid droplets adhering to the object can be evaporated and released to the ambient. In addition, the pressure release can also generate a fluid flow from all surfaces, thus can expel any liquid droplets from all surfaces and trapped spaces on the object or in the chamber, especially droplets at the vicinity of the outlet.

In some embodiments, the pressure release can provide an effective drying of the object, since the liquid vapor can be quickly evaporated when returning to atmospheric pressure, and liquid droplets can be pushed out of the chamber.

In some embodiments, the vapor medium can be supplied to the chamber through a reservoir. The reservoir can be heated to maintain a constant supply of liquid/vapor at the proper pressure, e.g., hyperbaric pressure, to the chamber.

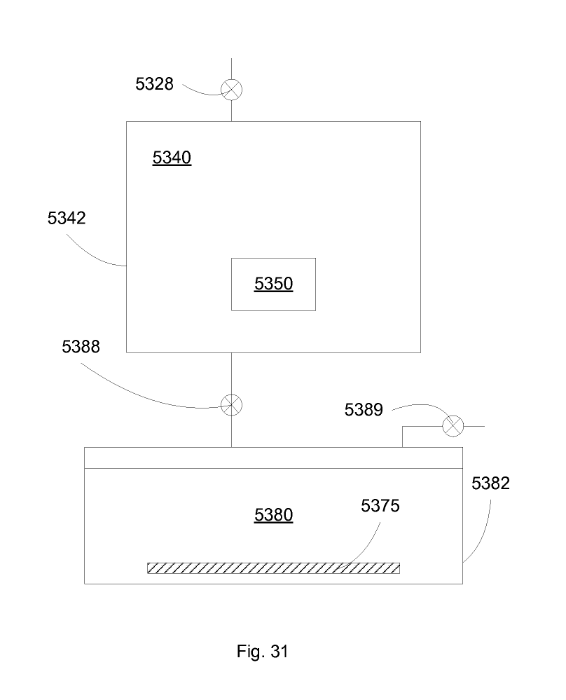

FIG. 31 illustrates an exemplary system configuration for cleaning and/or drying an object according to some embodiments. A reservoir 5382 can supply high energy vapor to a chamber 5342 through a valve 5388. Heater 5375 can be used to heat the liquid 5380 to a pressure above atmospheric pressure. Heater 5375 can be constantly heated to maintain the proper temperature and pressure for the liquid 5380. Valve 5389 can be used to supply pressurized gas to the reservoir. Valve 5388 can be open to deliver the heated vapor to the chamber 5342, submerging the object 5350 within vapor 5340. A relief valve 5328 is included to release the vapor, drying the object with the Rapid Displacement Drying method.

In some embodiments, the present invention discloses a heated and pressurized process fluid supply reservoir is used to deliver hot vapor or steam under controlled pressure to the process chamber. The present invention further discloses a hyperbaric process chamber capable of receiving either liquid or vapor under pressure from the supply reservoir, and capable of releasing vapor under pressure from the process chamber to begin the cyclic nucleation process. The hyperbaric process chamber can be capable of releasing liquid under pressure from the process chamber to drain the chamber and to begin the Rapid Displacement Drying sequence. The present invention further discloses the use of a controlled process chamber pressure release to nucleate and expand vapor under pressure so that droplets of liquid remaining on or in the part after chamber has been drained will be rapidly displaced and vaporized.

In some embodiments, an object is partially or totally submerged in a gaseous medium in a sealed container. The gas can partially or totally fill the container. There can be some liquid in the container, or the container can be filled with gaseous medium. The gas medium has a vapor phase pressure above the atmospheric pressure. The pressure within the sealed container is decreased, for example, by opening a relief valve to the atmosphere. The pressure cycling is repeated, with the pressure cycles at above atmospheric pressure. The gaseous medium cycling can lead to surface processing and/or cleaning and drying of the object.

In some embodiments, the chamber pressure can be above the boiling pressure at the liquid temperature. For example, a saturated steam, which has pressure at the boiling pressure at the liquid temperature, can be further heated to increase the temperature and pressure.

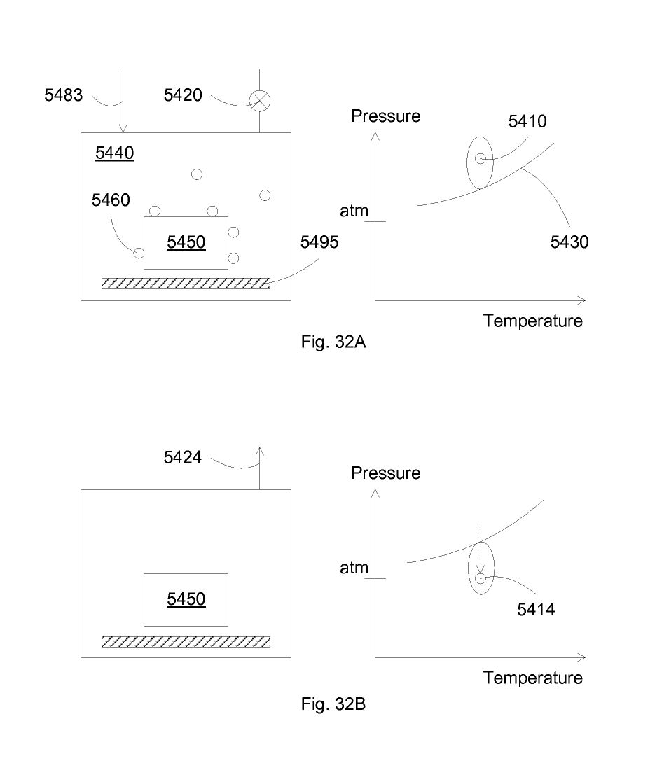

FIGS. 32A-32B illustrate another exemplary cleaning and drying process utilizing hyperbaric vapor pressure according to some embodiments. In FIG. 32A, an object 5450 is disposed in a chamber 5440, which is filled with high pressure and temperature vapor 5460, for example, superheated vapor from a container through conduit 5483. Valve 5420 is close to maintain high pressure within the chamber 5440. The vapor 5460 has pressure at or above the boiling pressure corresponded to its liquid temperature, e.g., having temperature-pressure state 5410 at or above the boiling curve 5430. For example, saturated steam can be at the boiling curve, while superheated steam can have pressure above the boiling curve pressure. An optional heater 5495 can be included to heat the chamber, for example, to heat a saturated steam to become a superheated steam. In addition, the pressure of the vapor 5460 is preferably above atmospheric pressure. For example, the vapor 5460 can be water vapor, e.g., steam, at pressure 5 bars and temperature 160° C. During the exposure to the high energy vapor 5460, the object can be cleaned, for example, sterilized due to the high temperature vapor. The chamber is shown to be without any liquid, but in some embodiments, liquid can be present.

In FIG. 32B, valve 5420 is quickly open (shown by valve state 5424), releasing the vapor 5460 to the ambient, e.g., atmospheric environment. The vapor state 5414 can be dropped to atmospheric pressure below the boiling curve, and any liquid droplets adhering to the object can be expelled and/or evaporated and released to the ambient. In addition, the expanding vapors can also generate a fluid flow from all surfaces, thus pushing out any liquid droplets trapped inside objects or in-between objects in the chamber, as well as any other liquids in the chamber, especially droplets at the vicinity of the outlet.

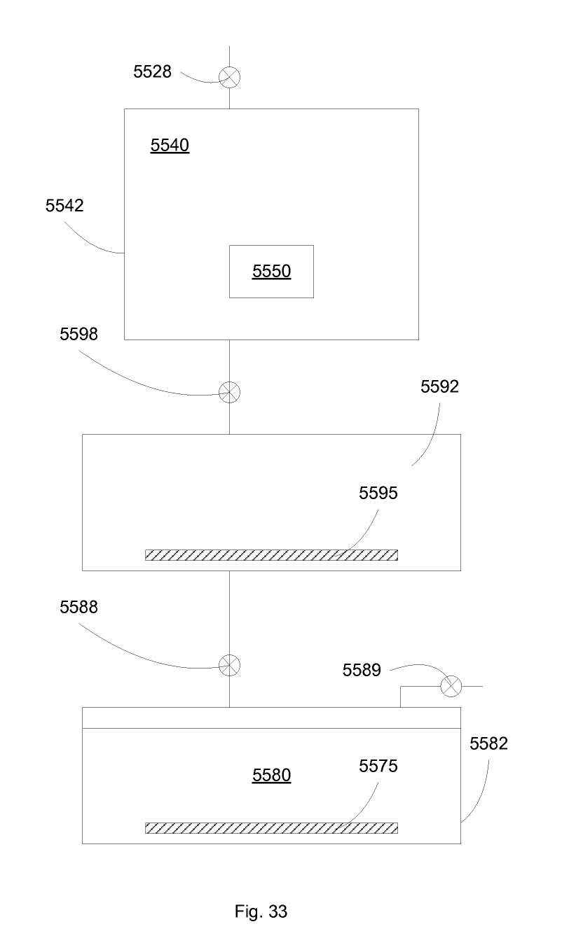

FIG. 33 illustrates another exemplary system configuration for cleaning and/or drying an object according to some embodiments. A reservoir 5582 can supply high energy vapor to a another chamber 5592 through valve 5588 for further heating the vapor through heater 5595, for example, turning saturated steam to superheated steam. The superheated steam can then be delivered to chamber 5542 through a valve 5598. Heater 5575 can be used to heat the liquid 5580 to a pressure above atmospheric pressure. Heater 5575 can be constantly heated to maintain the proper temperature and pressure for the liquid 5580. Valve 5589 can be used to supply pressurized gas to the reservoir. Valve 5588 can be open to deliver the heated vapor to the chamber 5542, submerging the object 5550 within vapor 5540. A relief valve 5528 is included to release the vapor, drying the object.

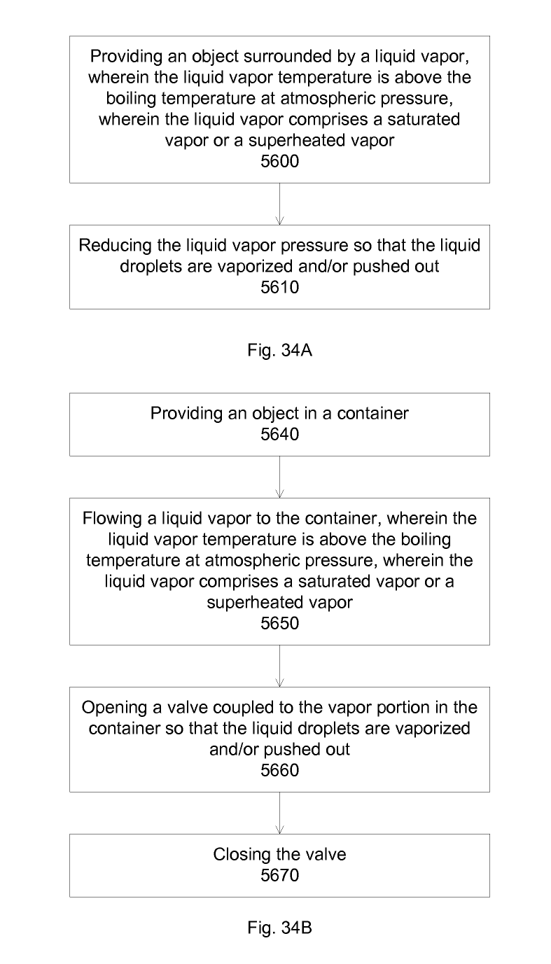

FIGS. 34A-34B illustrate exemplary flow charts for a hyperbaric drying process according to some embodiments. In FIG. 34A, operation 5600 provides an object surrounded by a liquid vapor, wherein the liquid vapor temperature is above the boiling temperature at atmospheric pressure, wherein the liquid vapor comprises a saturated vapor or a superheated vapor. Operation 5610 reduces the liquid vapor pressure so that the liquid vapor attached on surfaces of the object is removed, and the liquid droplets are pushed out. In some embodiments, the process can be repeated.

In FIG. 34B, operation 5640 provides an object in a container. Operation 5650 introduces a liquid vapor to the container, wherein the liquid vapor temperature is above the boiling temperature at atmospheric pressure, wherein the liquid vapor comprises a saturated vapor or a superheated vapor. Operation 5660 opens a valve coupled to the vapor portion in the container so that the liquid droplets are vaporized and/or pushed out. Operation 5670 closes the valve. In some embodiments, the process can be repeated.

In some embodiments, the present invention discloses a cleaning and drying process, using hyperbaric liquid and vapor. For example, a hyperbaric liquid (e.g., liquid at high temperature and pressure such as saturated water) can be used for cleaning, such as by a cyclic nucleation process. Then a hyperbaric vapor (e.g., vapor at high temperature and pressure, such as saturated or superheated steam) can be used for drying, such as by evaporation and expulsion of liquid droplets from surfaces, a.k.a. Rapid Displacement Drying.

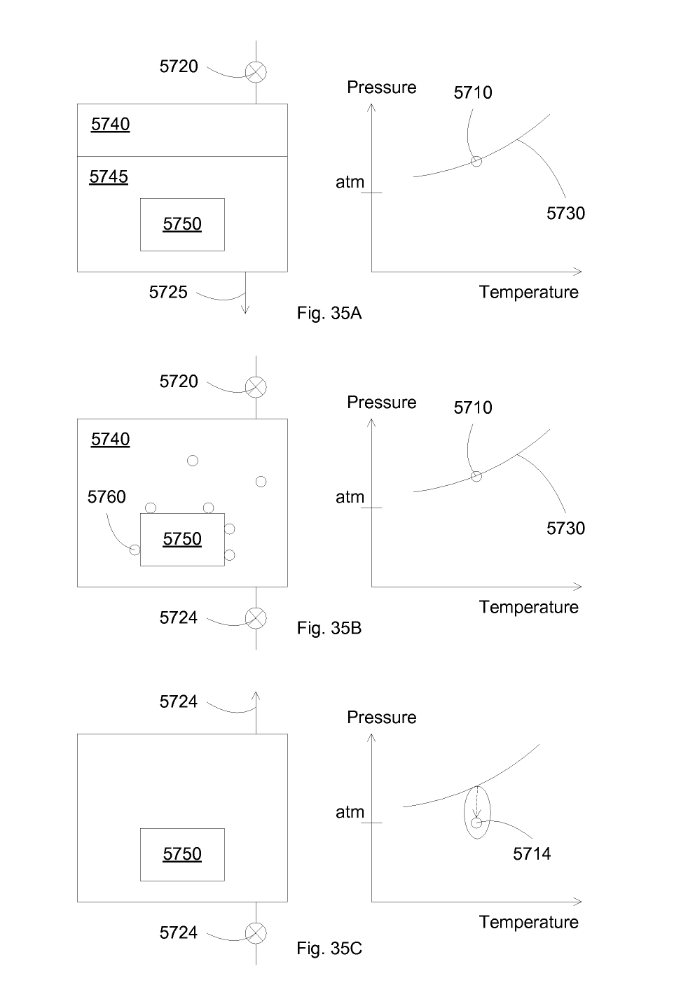

FIGS. 35A-35C illustrate an exemplary cleaning and drying process utilizing hyperbaric vapor pressure according to some embodiments. In FIG. 35A, an object 5750 is disposed in a chamber 5740, which is partially filled with high pressure and temperature liquid 5745, for example, to submerge the object, leaving a head space 5740. Valve 5720 is close to maintain high pressure within the chamber 5740. The vapor 5740 has pressure at or above the boiling pressure corresponded to its liquid temperature, e.g., having temperature-pressure state 5710 at or above the boiling curve 5730. For example, saturated steam can be at the boiling curve, while superheated steam can have pressure above the boiling curve pressure. In addition, the pressure of the vapor 5740 is preferably above atmospheric pressure. For example, the vapor 5740 can be water vapor, e.g., steam, at pressure 5 bars and temperature 160° C.

The object is then cleaned, for example, by a cyclic nucleation process with cycling pressure in the chamber. After cleaning, the liquid can be drained, for example, through conduit 5725.

In FIG. 35B, the liquid is drained, and drain valve 5724 is closed, leaving high pressure and high temperature vapor portion 5740, forming high energy vapor 5760 on the object. The object can also be cleaned and sterilized, for example, due to the high temperature vapor.

In FIG. 35C, valve 5720 is quickly open (shown by valve state 5724), releasing the vapor 5760 to the ambient, e.g., atmospheric environment. The vapor state 5714 can be dropped to atmospheric pressure below the boiling curve, and any liquid droplets adhering to the object can be evaporated and released to the ambient. In addition, the expanding vapors can also generate a fluid flow from all surfaces, thus pushing out any liquid droplets trapped inside objects or in-between objects in the chamber, as well as any other liquids in the chamber, especially droplets at the vicinity of the outlet.

In some embodiments, the pressure release can provide an effective drying of the object, since the liquid vapor can be quickly evaporated when returning to atmospheric pressure, and liquid droplets can be expelled from surfaces and trapped spaces and pushed out of the chamber.

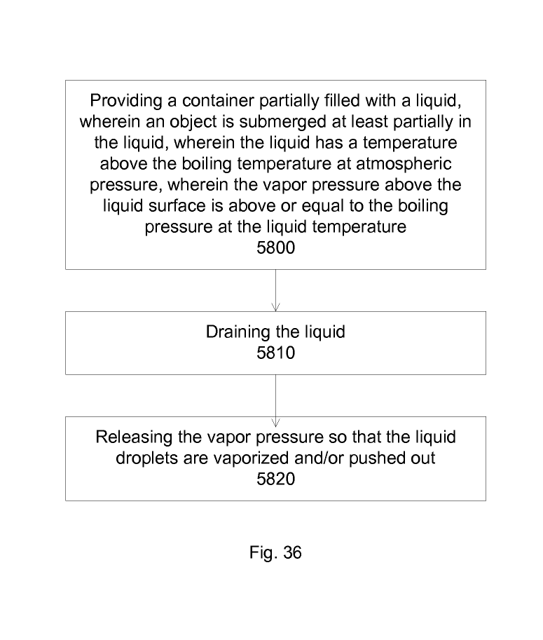

FIG. 36 illustrates another exemplary flow chart for a hyperbaric drying process according to some embodiments. Operation 5800 provides a container partially filled with a liquid, wherein an object is submerged at least partially in the liquid, wherein the liquid has a temperature above the boiling temperature at atmospheric pressure, wherein the vapor pressure above the liquid surface is above or equal to the boiling pressure corresponded to the liquid temperature. Operation 5810 drains the liquid. Operation 5820 releases the vapor pressure so that the liquid droplets are vaporized and/or pushed out. In some embodiments, the process can be repeated.

In an exemplary process, the process chamber is filled with liquid from the reservoir. Pressure is then cycled, for example, released for the formation of bubbles and increased for the termination of bubbles. The liquid can be drained and replaced with new liquid from the reservoir, and the cleaning cycle is repeated. After complete cleaning, the liquid is drained. The process chamber is filled with steam. Pressure can be cycled, for example, released by opening a relief valve and increased by adding new steam from the reservoir. After complete cleaning, the steam is released. The steam cleaning cycles can clean, dry and sterilize the object.

In some embodiments, the present invention discloses systems and processes for hyperbaric clean and dry process. The pressure can cycle between high and low pressure for cyclically cleaning the object with the high energy liquid. The pressure can be quickly released for drying the object, after cleaning is completed.

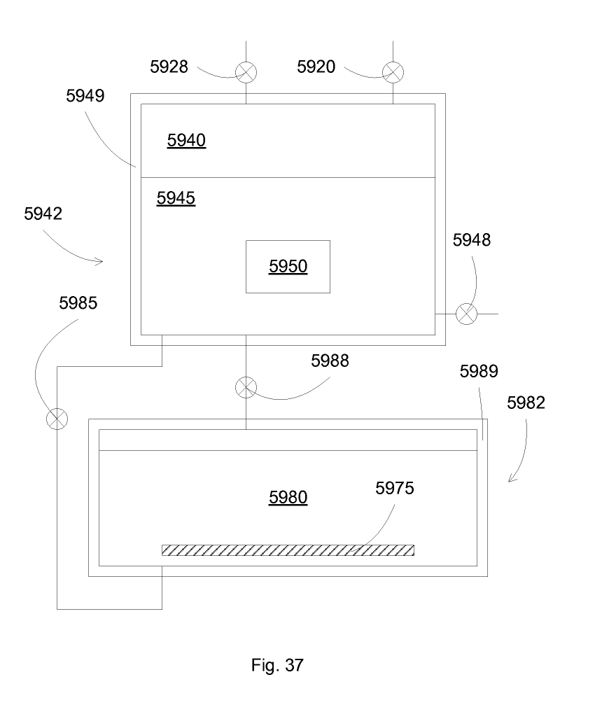

FIG. 37 illustrates an exemplary system configuration for cyclic cleaning and drying an object according to some embodiments. A reservoir 5982 can supply high energy liquid to chamber 5942 through a valve 5985, and high energy vapor through a valve 5988. Heater 5975 can be used to heat the liquid 5980 to a pressure above atmospheric pressure. Heater 5975 can be constantly heated to maintain the proper temperature and pressure for the liquid 5980. Valve 5985 can be open to deliver the heated liquid to the chamber 5942, submerging the object 5950 within liquid 5945, leaving vapor portion 5940. A relief valve 5920 is included to perform cyclic nucleation process, cleaning the object 5950 by cycling the high pressure to lower values, crossing the boiling curve for generating and terminating bubbles. A drain valve 5948 can be included for draining the liquid, for example, when the cleaning process is completed. In addition, valve 5988 can be open to deliver the heated vapor to the chamber 5942, submerging the object 5950 within vapor 5940 (preferably after the liquid has been drained). A relief valve 5928 is included to release the vapor, drying the object.

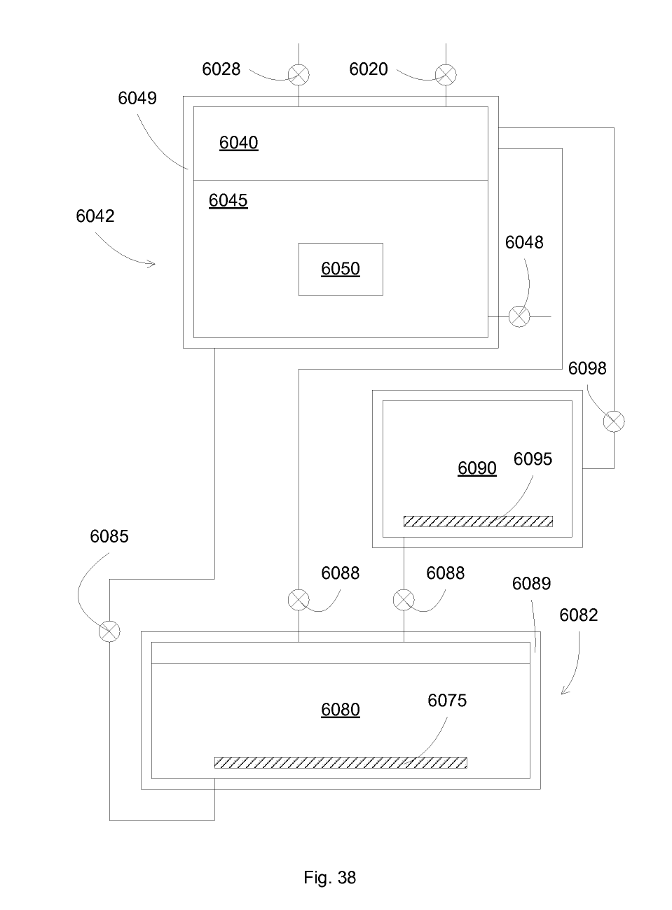

FIG. 38 illustrates an exemplary system configuration for cyclic processing and/or cleaning and drying an object according to some embodiments. A reservoir 6082 can supply high energy liquid to chamber 6042 through a valve 6085, and high energy vapor through a valve 6088. Heater 6075 can be used to heat the liquid 6080 to a pressure above atmospheric pressure. Heater 6075 can be constantly heated to maintain the proper temperature and pressure for the liquid 6080. Valve 6085 can be open to deliver the heated liquid to the chamber 6042, submerging the object 6050 within liquid 6045, leaving vapor portion 6040. A relief valve 6020 is included to perform cyclic nucleation process on the object 6050 by cycling the high pressure to lower values, crossing the boiling curve for generating and terminating bubbles. A drain valve 6048 can be included for draining the liquid, for example, when the process is completed. In addition, valve 6088 can be open to deliver the heated vapor to the chamber 6042, submerging the object 6050 within vapor 6040 (preferably after the liquid has been drained). A relief valve 6028 is included to release the vapor, drying the object. An additional container 6090 comprising a heater 6095 can be included to supply heated vapor to the process chamber through valve 6098.

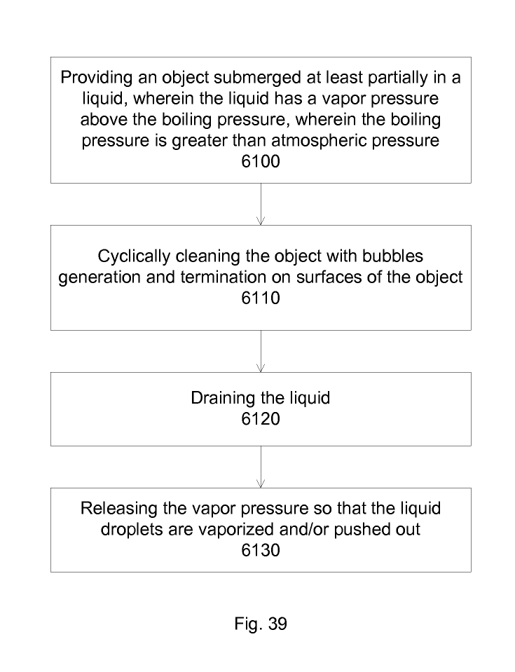

FIG. 39 illustrates an exemplary flow chart for a hyperbaric cyclic cleaning (or other processing) and drying process according to some embodiments. Operation 6100 provides an object submerged at least partially in a liquid, wherein the liquid has a vapor pressure above the boiling pressure, wherein the boiling pressure is greater than atmospheric pressure. Operation 6110 reduces the vapor pressure in a stepwise fashion so that bubbles are generated and collapsed on surfaces of the object. Operation 6120 drains the liquid. Operation 6130 releases the vapor pressure so that the liquid vapor attached on surfaces of the object is removed.

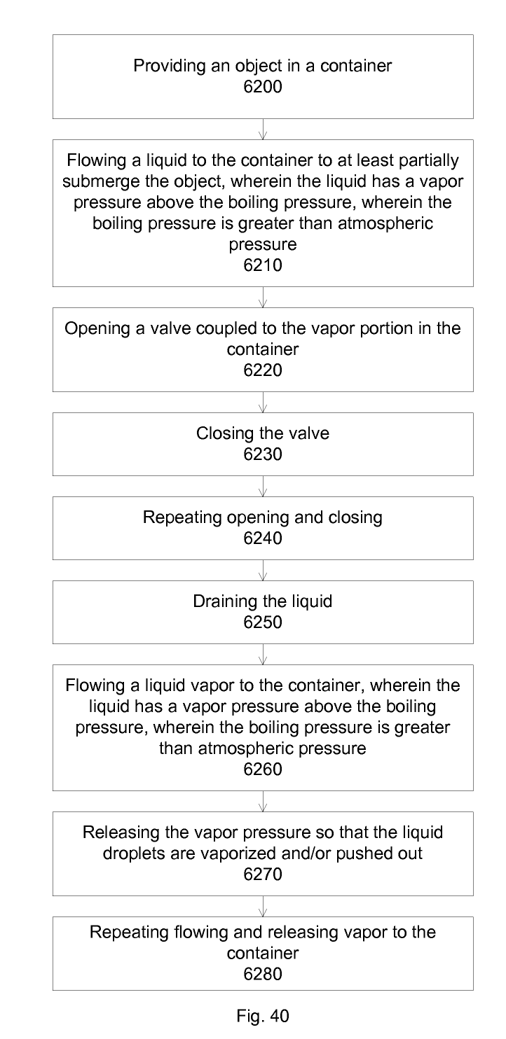

FIG. 40 illustrates an exemplary flow chart for a hyperbaric cyclic cleaning/processing and drying process according to some embodiments. Operation 6200 provides an object in a container. Operation 6210 adds a liquid to the container to at least partially submerge the object, wherein the liquid has a vapor pressure above the boiling pressure, wherein the boiling pressure is greater than atmospheric pressure. Operation 6220 opens a valve coupled to the vapor portion in the container. Operation 6230 closes the valve. Operation 6240 repeats the steps of opening and closing. Operation 6250 drains the liquid. Operation 6260 adds a liquid vapor to the container, wherein the liquid has a vapor pressure above the boiling pressure, wherein the boiling pressure is greater than atmospheric pressure. Operation 6270 releases the vapor pressure so that the liquid vapor attached on surfaces of the object is removed. Operation 6280 repeats the steps of flowing and releasing vapor to the container.

In some embodiment, drying methods using hyperbaric pressure are provided. The methods can include providing an object in a chamber; flowing a superheated vapor to the chamber, wherein the superheated vapor has a temperature above the boiling temperature at atmospheric pressure; draining the superheated vapor.

In some embodiment, the superheated vapor can include superheated steam. The superheated vapor can be drained at a rate configured to evaporate liquid droplets adhering to the object. The temperature of the superheated vapor can be between 110 and 200 C. the pressure of the superheated vapor can be between 1 and 20 bars.

In some embodiment, the methods can further include adding a new superheated vapor to the chamber; and then draining the new superheated vapor.

In some embodiment, drying methods using hyperbaric pressure are provided. The methods can include providing an object in a chamber; flowing a superheated liquid to the chamber, wherein the superheated liquid has a temperature above the boiling temperature at atmospheric pressure, wherein the superheated liquid partially fills the chamber so that the chamber comprises a liquid portion and a vapor portion; draining the liquid portion of the superheated liquid; draining the vapor portion of the superheated vapor.

In some embodiment, the superheated liquid can be drained to a second chamber, wherein the pressure of the second chamber is similar to that of the first chamber. The superheated vapor can be drained at a rate configured to evaporate liquid droplets adhering to the object. The temperature of the superheated vapor can be between 110 and 200 C. The pressure of the superheated vapor can be between 1 and 20 bars. The temperature of the superheated liquid can be between 110 and 200 C. The pressure of the superheated liquid can be between 1 and 20 bars.

In some embodiment, the methods can further include repeating flowing a superheated vapor and draining the superheated vapor. The methods can also include supplying a new superheated liquid to the chamber; draining the new superheated liquid while maintaining keeping the chamber pressure; and draining the vapor in the chamber.

In some embodiment, drying methods using hyperbaric pressure are provided. The methods can include providing an object in a chamber; cleaning the object with a superheated liquid in the chamber, wherein the superheated liquid has a temperature above the boiling temperature at atmospheric pressure; draining the superheated liquid while maintaining keeping the chamber pressure; draining the vapor in the chamber.

In some embodiment, the superheated vapor can be drained at a rate configured to evaporate liquid droplets adhering to the object. The temperature of the superheated liquid can be between 110 and 200 C. The pressure of the superheated liquid can be between 1 and 20 bars. Cleaning the object with a superheated liquid can include repeatedly connecting the vapor portion of the chamber to an ambient, wherein the ambient has lower vapor pressure than the chamber; connecting the vapor portion of the chamber to a vapor portion of a reservoir, wherein the reservoir comprises a superheated liquid, wherein the superheated liquid in the reservoir is heated to a temperature at or above the temperature of the superheated in the chamber. Cleaning the object with a superheated liquid can include repeatedly connecting the vapor portion of the chamber to an ambient, wherein the ambient has lower vapor pressure than the chamber; connecting the vapor portion of the chamber to a heated vapor or heated gas, wherein the heated vapor or heated gas is heated to a temperature at or above the temperature of the superheated in the chamber. Cleaning the object with a superheated liquid can include repeatedly releasing pressure in the chamber; stopping the pressure release.

In some embodiment, the methods can further include adding a new superheated vapor to the chamber; and draining the new superheated vapor. The methods can also include supplying a new superheated liquid to the chamber; draining the new superheated liquid while maintaining keeping the chamber pressure; and draining the vapor in the chamber.

In some embodiments, a Vacuum Condenser Pressure Release Container (VCPRC) is provided. The vapor released from the chamber during the H-CNX process may be released to a special pressure release container (VCPRC). The advantages of using a VCPRC are several: The high pressure vapors released have considerable heat and energy and containment of the hot vapors addresses safety concerns. Also, since the vapors trapped in the VCPRC can be condensed to liquid by means of external cooling, the pressure in the VCPRC will reach vacuum levels as the vapors condense to liquid. This will increase the potential pressure drop achievable in the CNX process. Furthermore, since the liquid medium may be an expensive or environmentally unfriendly chemical, the condensed vapors are easily contained for proper disposal or recycling.

In some embodiments, a VCPRC can include a condenser coil, such as a conduit line filled with circulating cooling fluid. The condenser coil can include any assembly that can condense a vapor to a liquid phase. The VCPRC can include a drain valve to drain any condensed liquid. The VCPRC can include a gas escape valve to release the gas within the VCPRC. The VCPRC can include a coupling conduit to allow coupling to a hyperbaric chamber, The coupling conduit can include an isolation assembly, such as a valve to connect to or disconnect the hyperbaric chamber from the VCPRC.

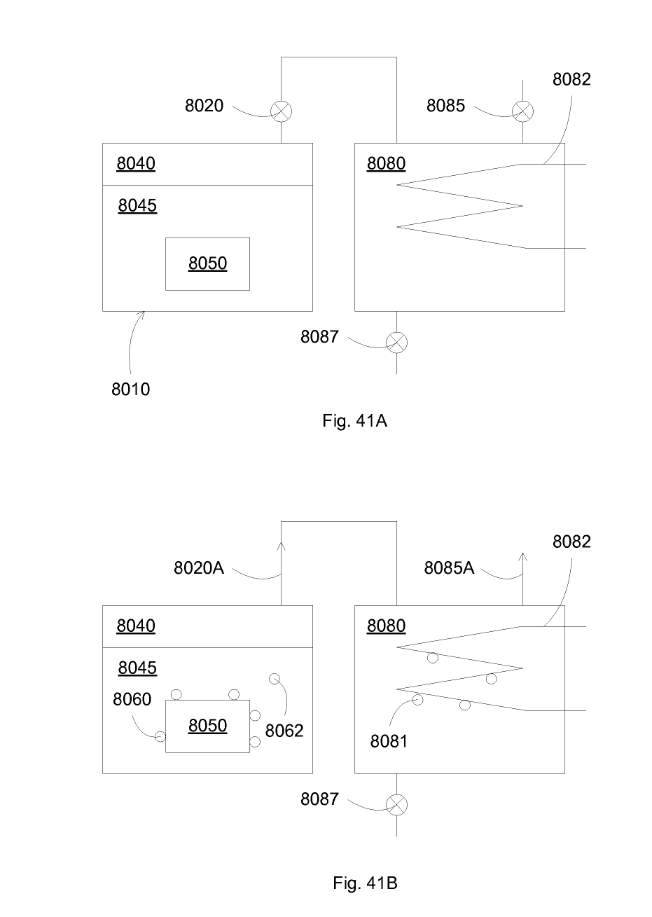

FIGS. 41A-41B illustrate a schematic of a VCPRC and a process to prepare the VCPRC to be used with a hyperbaric chamber according to some embodiments. In FIG. 41A shows a VCPRC 8080 can include a vent valve 8085 and a drain valve 8087. The VCPRC can also include a cooling loop 8082 with coolant flow which can be used to cool and condense vapors. In some embodiments, the VCPRC is initially filled with air at atmosphere. The VCPRC can include an inlet for coupling to an external chamber, such as a hyperbaric chamber.

During operation, the VCPRC is coupled to a hyperbaric chamber 8060 through a relief valve 8020. The chamber 8010 contains an object 8050 submerged or partially submerged under a superheated liquid 8045. The container is at least partially filled with liquid 8045, leaving headspace 8040 to accommodate liquid vapor. The liquid is preferably held above its atmospheric boiling temperature and at elevated pressure.

FIG. 41B shows a typical non-condensable gas purge step. This step can be used to expel air from the VCPRC. Relieve valve 8020 is open (identified as 8020A) which creates bubbles in the chamber 8010 and releases vapor under pressure to the VCPRC. The VCPRC has the vent valve 8085 open (identified as 8085A) for purging purpose. Vapor entering the VCPRC displaces air from the chamber which escapes through open vent 8085 and the expanding vapor also begins to condense into droplets of liquid 8081 on the cooling coils 8082. Once enough air is expelled, both the vent and relief valves many be closed. At this point the vapor in the VCPRC has mostly condensed onto the cooling coils and is collected at the bottom of the chamber 8080, leaving the pressure typically at a vacuum. Other methods can be used to create a vacuum in the VCPRC, such as connecting a vacuum pump to the VCPRC.

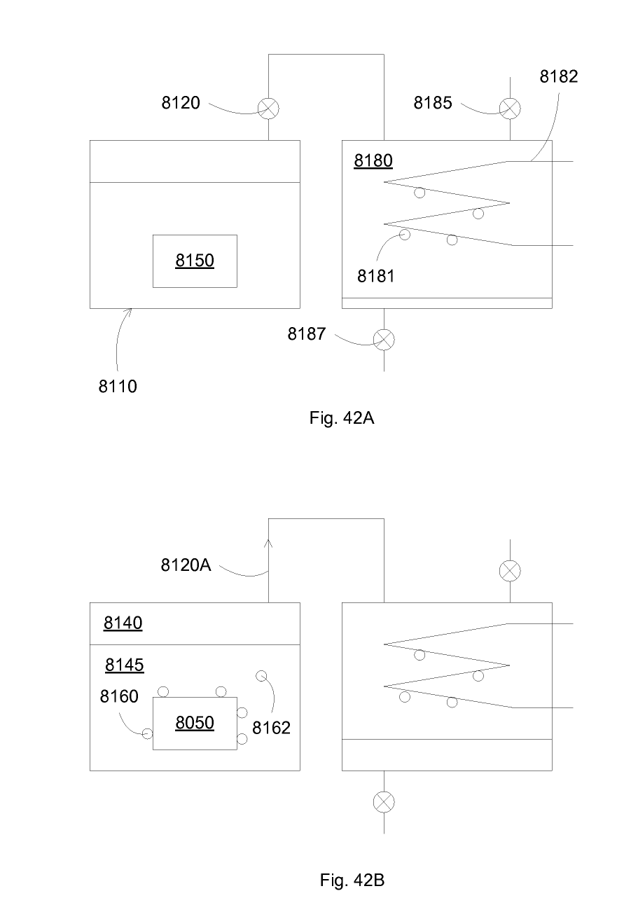

FIGS. 42A-42B illustrate an operation of a hyperbaric process using a VCPRC according to some embodiments. In FIG. 42A, the relief valve 8020 is close, and the hyperbaric chamber 8110 is in a pressurized mode with no bubbles. After the VCPRC 8180 is initialized, the drain valve 8187 and the vent valve 8185 are close. Some liquid droplets 8181 can be condensed on a cooling coil 8182. The pressure-temperature diagrams show conditions for both the process chamber and the VCPRC during the pressure step.

In FIG. 42B, subsequent CNX cycles involving opening the relief valve 8120 (identified as 8120A) to release pressure in hyperbaric chamber 8110. Pressure begins to rise in the VCPRC but the entering vapor is quickly condensed on the cooling coils 8182 and collected at the bottom of the chamber 8180. Upon closing the relief valve 8120 the system returns to a configuration where the chamber typically rises to above atmospheric pressure and the VCPRC pressure typically drops to sub-atmospheric levels.

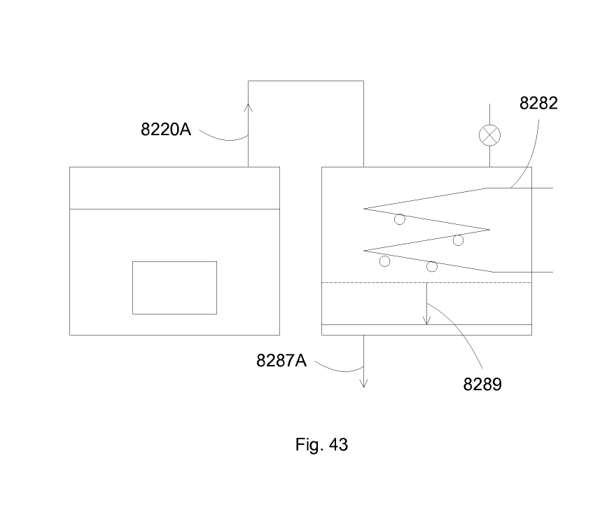

FIG. 43 illustrates a draining operation for a VCPRC according to some embodiments. At some point the condensed liquid level rises in the VCPRC to a level where it may be drained for disposal or recycling. Relief valve 8220A is open, just like for any CNX cycle, and as the pressure begins to rise above vacuum in the VCPRC, the drain valve is opened 8287A to drain condensate 8282 out of the chamber. Upon completing the drain 8289 both valves are then closed and the system returns to the steady state condition.

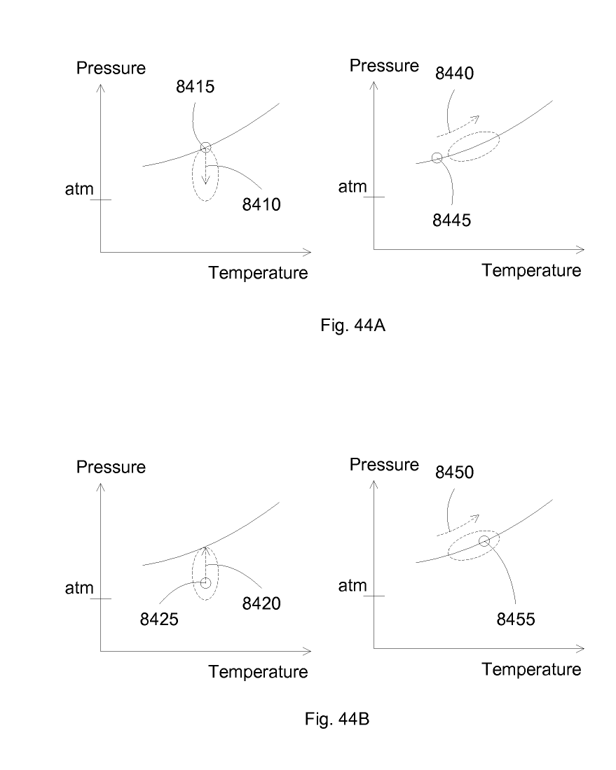

FIGS. 44A-44B illustrate pressure-temperature diagrams according to some embodiments. FIG. 44A shows a pressure-temperature diagram showing conditions for both the process chamber and the VCPRC during the pressure release step. In the process chamber, the pressure 8415 is quickly reduced 8410. In the VCPRC, the pressure 8445 slowly increases 8440. FIG. 44B shows a pressure-temperature diagram showing conditions for both the process chamber and the VCPRC during the re-pressurization step. In the process chamber, the pressure 8425 quickly rises 8420. In the VCPRC, the pressure 8455 slowly increases 8450.

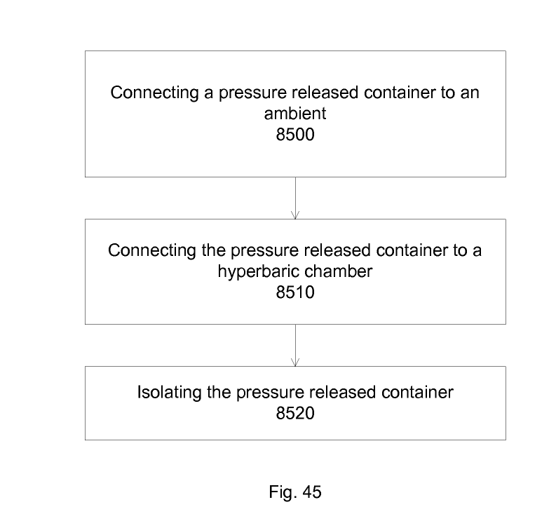

FIG. 45 illustrates a flow chart for initializing a VCPRC according to some embodiments. Operation 8500 connects a pressure released container to an ambient. Operation 8510 connects the pressure released container to a hyperbaric chamber. Operation 8520 isolates the pressure released container.

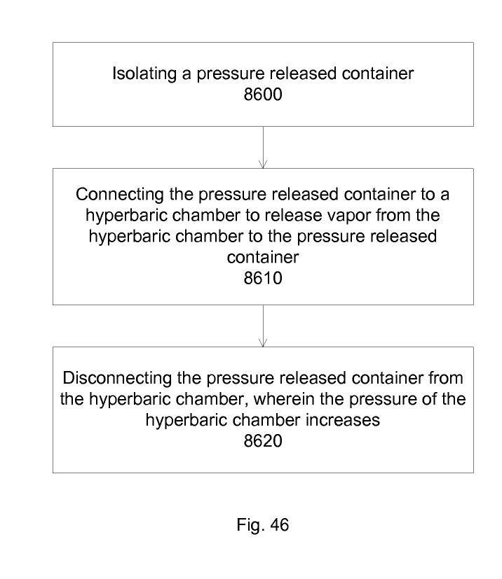

FIG. 46 illustrates a flow chart for running a VCPRC according to some embodiments. Operation 8600 isolates a pressure released container. Operation 8610 connects the pressure released container to a hyperbaric chamber to release vapor from the hyperbaric chamber to the pressure released container. Operation 8620 disconnects the pressure released container from the hyperbaric chamber, wherein the pressure of the hyperbaric chamber increases.

What is claimed is:

1. A cleaning method using hyperbaric pressure, the method comprising providing an object in a chamber;
flowing a superheated liquid to the chamber to at least partially submerge the object,
wherein the superheated liquid has a temperature above the boiling temperature at atmospheric pressure,
wherein the superheated liquid partially fills the chamber so that the chamber comprises a liquid portion and a vapor portion;
repeatedly
connecting the vapor portion of the chamber to an ambient,
wherein the ambient has lower vapor pressure than the chamber;
disconnecting the connection.

2. A method as in claim 1 wherein connecting the vapor portion of the chamber to the ambient reduces the pressure of the chamber, wherein the reduced pressure is configured to generate bubbles at a surface of the object.

3. A method as in claim 1 wherein disconnecting the connection of the vapor portion of the chamber to the ambient increases the vapor pressure of the chamber due to the vaporization of the liquid portion of the chamber, wherein the increased pressure is configured to terminate generated bubbles.

4. A method as in claim 1 wherein the superheated liquid comprises water at temperature above 100 C.

5. A method as in claim 1 wherein the temperature of the superheated liquid is between 110 and 200 C, wherein the pressure of the superheated liquid is between 1 and 20 bars.

6. A method as in claim 1 further comprising
draining a portion of the superheated liquid from the chamber;
adding a new superheated liquid to the chamber.

7. A method as in claim 1 further comprising
repeating flowing a superheated liquid and periodically cycling pressure.

8. A method as in claim 1 further comprising
repeating flowing a superheated liquid, periodically cycling pressure, and draining the superheated liquid.

9. A cleaning method using hyperbaric pressure, the method comprising
providing an object in a chamber;
flowing a superheated liquid to the chamber to at least partially submerge the object,
wherein the superheated liquid has a temperature above the boiling temperature at atmospheric pressure,
wherein the superheated liquid partially fills the chamber so that the chamber comprises a liquid portion and a vapor portion;
repeatedly
connecting the vapor portion of the chamber to an ambient,
wherein the ambient has lower vapor pressure than the chamber;
connecting the vapor portion of the chamber to a vapor portion of a reservoir,
wherein the reservoir comprises a superheated liquid.

10. A method as in claim 9 wherein connecting the vapor portion of the chamber to the ambient reduces the vapor pressure of the chamber by releasing the vapor pressure of the chamber.

11. A method as in claim 9 wherein connecting the vapor portion of the chamber to the vapor portion of the reservoir increases the vapor pressure of the chamber by supplying a superheated vapor to the chamber.

12. A method as in claim 9 wherein the superheated liquid comprises water at temperature above 100 C.

13. A method as in claim 9 wherein the temperature of the superheated liquid is between 110 and 200 C, wherein the pressure of the superheated liquid is between 1 and 20 bars.

14. A method as in claim 9 further comprising
heating the superheated liquid in the reservoir to a temperature at or above the temperature of the superheated in the chamber.

15. A cleaning method using hyperbaric pressure, the method comprising
providing an object in a chamber;
flowing a superheated liquid to the chamber to at least partially submerge the object,
wherein the superheated liquid has a temperature above the boiling temperature at atmospheric pressure,
wherein the superheated liquid partially fills the chamber so that the chamber comprises a liquid portion and a vapor portion;
repeatedly
connecting the vapor portion of the chamber to an ambient,
wherein the ambient has lower vapor pressure than the chamber;
connecting the vapor portion of the chamber to a heated vapor or heated gas.

16. A method as in claim 15 wherein connecting the vapor portion of the chamber to the ambient reduces the vapor pressure of the chamber by releasing the vapor pressure of the chamber.

17. A method as in claim 15 wherein connecting the vapor portion of the chamber to the vapor portion of the reservoir increases the vapor pressure of the chamber by supplying a superheated vapor to the chamber.

18. A method as in claim 15 wherein the superheated liquid comprises water at temperature above 100 C.

19. A method as in claim 15 wherein the temperature of the superheated liquid is between 110 and 200 C, wherein the pressure of the superheated liquid is between 1 and 20 bars.

20. A method as in claim 15 further comprising
heating the heated vapor or heated gas to a temperature at or above the temperature of the superheated in the chamber.
